(19) United States
(12) Patent Application Publication
(10) Pub. No.: US 2026/0261431 A1
(43) Pub. Date: Sep. 3, 2026

(54) SYSTEM AND METHOD FOR HUMAN IDENTITY-BOUND CRYPTOGRAPHIC SIGNING OF DIGITAL COMMUNICATIONS

(71) Applicant: THE MIRROR PROJECT LLC, Boca Raton, FL (US)

(72) Inventor: Scott M. Lipskin, Boca Raton, FL (US)

(73) Assignee: THE MIRROR PROJECT LLC, Boca Raton, FL (US)

(21) Appl. No.: 19/655,411

(22) Filed: Apr. 22, 2026

Related U.S. Application Data
(63) Continuation-in-part of application No. 19/648,201, filed on Apr. 15, 2026.
(63) Continuation-in-part of application No. 19/455,887, filed on Jan. 22, 2026.
(63) Continuation-in-part of application No. 19/461,799, filed on Jan. 28, 2026.
(63) Continuation-in-part of application No. 19/534,902, filed on Feb. 10, 2026.
(63) Continuation-in-part of application No. 19/576,524, filed on Mar. 24, 2026.
(63) Continuation-in-part of application No. 19/635,099, filed on Mar. 31, 2026.
Application No. 19/455,887 is a continuation-in-part of application No. 19/452,930, filed on Jan. 20, 2026.
Application No. 19/452,930 is a continuation-in-part of application No. 19/438,974, filed on Jan. 2, 2026.
Application No. 19/438,974 is a continuation-in-part of application No. 19/436,069, filed on Dec. 30, 2025.
Application No. 19/436,069 is a continuation-in-part of application No. 19/432,500, filed on Dec. 24, 2025.
Application No. 19/432,500 is a continuation-in-part of application No. 19/425,024, filed on Dec. 18, 2025.
Application No. 19/576,524 is a continuation-in-part of application No. 19/461,799, filed on Jan. 28, 2026.
Application No. 19/461,799 is a continuation-in-part of application No. 19/534,902, filed on Feb. 10, 2026.
Application No. 19/635,099 is a continuation-in-part of application No. 19/455,887, filed on Jan. 22, 2026.
Application No. 19/455,887 is a continuation-in-part of application No. 19/461,799, filed on Jan. 28, 2026.
Application No. 19/461,799 is a continuation-in-part of application No. 19/534,902, filed on Feb. 10, 2026.
Application No. 19/534,902 is a continuation-in-part of application No. 19/576,524, filed on Mar. 24, 2026.
(60) Provisional application No. 63/922,189, filed on Nov. 21, 2025.
(60) Provisional application No. 63/926,018, filed on Nov. 26, 2025.
(60) Provisional application No. 63/981,418, filed on Feb. 12, 2026.
(60) Provisional application No. 63/981,418, filed on Feb. 12, 2026.
(60) Provisional application No. 64/014,310, filed on Mar. 23, 2026.
(60) Provisional application No. 64/014,310, filed on Mar. 23, 2026.
(60) Provisional application No. 64/014,310, filed on Mar. 23, 2026.
(60) Provisional application No. 64/020,009, filed on Mar. 28, 2026.
(60) Provisional application No. 64/020,009, filed on Mar. 28, 2026.
(60) Provisional application No. 64/024,925, filed on Apr. 1, 2026.

(51) Int. Cl. H04L 9/32; H04L 9/08

(52) U.S. Cl. CPC H04L 9/3247; H04L 9/0825; H04L 9/0852; H04L 9/0891

(57) ABSTRACT

A system (100) for authenticating digital communications comprises a sender layer (102) and a receiver layer (104). The sender layer (102) comprises a signing layer (110) configured to intercept outbound communications from a verified human identity prior to transmission, wherein the verified human identity is registered to a public identity record (109), an identity anchor (108) binding a signing key to the verified human identity, and a verification artifact generated by the signing layer (110), the verification artifact encoding the identity anchor (108) of the verified human identity. The receiver layer (104) comprises a public verification protocol (114) enabling a receiving system to receive the outbound communications and validate the verification artifact against the public identity record (109) to confirm authenticity of the outbound communications.

### CROSS-REFERENCE TO RELATED APPLICATIONS

This application is a continuation-in-part patent application, which claims priority to and claims the benefit of each of the following applications, the contents of each of which are incorporated herein by reference in their entirety:

U.S. patent application Ser. No. 19/648,201, filed Apr. 15, 2026; U.S. patent application Ser. No. 19/455,887, filed Jan. 22, 2026; U.S. patent application Ser. No. 19/461,799, filed Jan. 28, 2026; U.S. patent application Ser. No. 19/534,902, filed Feb. 10, 2026; U.S. patent application Ser. No. 19/576,524, filed Mar. 24, 2026; U.S. patent application Ser. No. 19/635,099, filed Mar. 31, 2026; U.S. Provisional Patent Application Ser. No. 63/981,418, filed Feb. 12, 2026; U.S. Provisional Patent Application Ser. No. 64/014,310, filed Mar. 23, 2026; U.S. Provisional Patent Application Ser. No. 64/020,009, filed Mar. 28, 2026; and U.S. Provisional Patent Application Ser. No. 64/024,925, filed Apr. 1, 2026.

U.S. patent application Ser. No. 19/455,887 is itself a continuation-in-part application claiming priority to U.S. patent application Ser. No. 19/452,930, filed Jan. 20, 2026; U.S. patent application Ser. No. 19/440,705, filed Jan. 6, 2026; U.S. patent application Ser. No. 19/438,974, filed Jan. 2, 2026; U.S. patent application Ser. No. 19/436,069, filed Dec. 30, 2025; U.S. patent application Ser. No. 19/432,500, filed Dec. 24, 2025; U.S. patent application Ser. No. 19/425,024, filed Dec. 18, 2025; U.S. Provisional Patent Application Ser. No. 63/926,018, filed Nov. 26, 2025; and U.S. Provisional Patent Application Ser. No. 63/922,189, filed Nov. 21, 2025, the contents of each of which are incorporated herein by reference in their entirety.

U.S. patent application Ser. No. 19/576,524 is itself a continuation-in-part application claiming priority to U.S. patent application Ser. No. 19/461,799, filed Jan. 28, 2026; U.S. patent application Ser. No. 19/534,902, filed Feb. 10, 2026; and U.S. Provisional Patent Application Ser. No. 64/014,310, filed Mar. 23, 2026, the contents of each of which are incorporated herein by reference in their entirety.

U.S. patent application Ser. No. 19/635,099 is itself a continuation-in-part application claiming priority to U.S. patent application Ser. No. 19/455,887, filed Jan. 22, 2026; U.S. patent application Ser. No. 19/461,799, filed Jan. 28, 2026; U.S. patent application Ser. No. 19/534,902, filed Feb. 10, 2026; U.S. patent application Ser. No. 19/576,524, filed Mar. 24, 2026; U.S. Provisional Patent Application Ser. No. 63/981,418, filed Feb. 12, 2026; U.S. Provisional Patent Application Ser. No. 64/014,310, filed Mar. 23, 2026; and U.S. Provisional Patent Application Ser. No. 64/020,009, filed Mar. 28, 2026, the contents of each of which are incorporated herein by reference in their entirety.

### TECHNICAL FIELD

The present invention relates to cryptographic authentication of digital communications, and more particularly to human identity-bound signing and AI-assistance state provenance for outbound digital communications.

### BACKGROUND

Digital communications transmitted over email, short message service (SMS), instant messaging, and other channels are increasingly subject to spoofing, impersonation, and AI-generated fraud. Bad actors can fabricate messages that appear to originate from a known and trusted sender, and artificial intelligence (AI) tools can generate correspondence that precisely mimics a real person's voice and style. These threats have rendered it virtually impossible for recipients to verify, without external tools, whether a given digital communication originated from the person it purports to represent.

Existing authentication protocols operate at the carrier or domain level and do not address individual human identity. DomainKeys Identified Mail (DKIM), as specified in the DKIM specification published by the Internet Engineering Task Force (IETF) as Request for Comments 6376, signs outbound email on behalf of a domain using a server-side key, such that any authorized user of that domain's mail infrastructure can produce a valid signature. Secure Telephone Identity Revisited/Signature-based Handling of Asserted Information Using Tokens (STIR/SHAKEN) authenticates telephone calls at the carrier level but covers less than half of calls placed in the United States. Secure/Multipurpose Internet Mail Extensions (S/MIME) and Pretty Good Privacy (PGP) provide message-level signing but are limited to email and require prior key exchange between parties. None of these protocols bind a signed communication to a specific verified human being sending from a specific enrolled device.

No existing standard addresses the provenance of AI-generated text correspondence. The Coalition for Content Provenance and Authenticity (C2PA) standard provides content provenance for images and video but does not extend to text-based communications. No protocol currently encodes whether a given message was written by a human, edited with AI assistance, or generated entirely by an AI system acting under human authorization. Recipients therefore have no mechanism to assess the nature or origin of the communications they receive.

What is needed is a channel-agnostic system that binds outbound digital communications to a verified human identity at the individual and device level, encodes AI-assistance state in a tamper-evident artifact, and closes the verification loop by requiring a registered authenticator on the receiving end.

### SUMMARY

A system for authenticating digital communications is provided. The system comprises a signing layer configured to intercept outbound communications from a verified human identity prior to transmission, wherein the verified human identity is registered to a public identity record; an identity anchor binding a signing key to the verified human identity; and a verification artifact generated by the signing layer, the verification artifact encoding the identity anchor of the verified human identity.

A method for authenticating digital communications is provided. The method comprises intercepting, by a signing layer, outbound communications from a verified human identity prior to a transmission of the outbound communications, wherein the verified human identity is registered to a public identity record; binding, by an identity anchor, a signing key to the verified human identity; and producing, by the signing layer, a verification artifact encoding the identity anchor of the verified human identity.

A system for authenticating digital communications is provided. The system comprises a sender layer and a receiver layer. The sender layer comprises a signing layer configured to intercept outbound communications from a verified human identity prior to transmission, wherein the verified human identity is registered to a public identity record; an identity anchor that binds a signing key to the verified human identity; and a verification artifact generated by the signing layer, wherein the verification artifact encodes the identity anchor of the verified human identity. The receiver layer comprises a public verification protocol enabling a receiving system to receive the outbound communications and validate the verification artifact against the public identity record to confirm authenticity of the outbound communications.

A method for authenticating digital communications is provided. The method comprises intercepting, by a signing layer, outbound communications from a verified human identity prior to a transmission of the outbound communications, wherein the verified human identity is registered to a public identity record; binding, by an identity anchor, a signing key to the verified human identity; producing, by the signing layer, a verification artifact encoding the identity anchor of the verified human identity; receiving, by a receiver layer, the outbound communications; and validating, by a public verification protocol on the receiver layer, the verification artifact against the public identity record to confirm authenticity of the outbound communications.

A system for authenticating digital communications is provided. The system comprises a signing layer configured to intercept outbound communications from a verified human identity prior to transmission, wherein the verified human identity is registered to a public identity record; an identity anchor binding a signing key to the verified human identity; and a verification artifact generated by the signing layer, wherein the verification artifact encodes the identity anchor of the verified human identity.

A method for authenticating digital communications is provided. The method comprises intercepting, by a signing layer, outbound communications from a verified human identity prior to a transmission of the outbound communications, wherein the verified human identity is registered to a public identity record; binding, by an identity anchor, a signing key to the verified human identity; and producing, by the signing layer, a verification artifact encoding the identity anchor of the verified human identity.

### ASPECTS

According to an aspect, a system for authenticating digital communications comprises a signing layer configured to intercept outbound communications from a verified human identity prior to transmission, wherein the verified human identity is registered to a public identity record; an identity anchor binding a signing key to the verified human identity; and a verification artifact generated by the signing layer, the verification artifact encoding the identity anchor of the verified human identity.

Preferably, the verification artifact comprises one or more verifiable elements generated using at least one of: a cryptographic method, a post-quantum cryptographic method, a quantum-derived process, a biometric input, and a device-bound credential, wherein validation of the verification artifact is independent of any specific cryptographic scheme and is based on satisfaction of at least one authorization condition associated with the outbound communications.

Preferably, the verification artifact includes a component derived from a quantum process, comprising at least one of a quantum randomness, a quantum state measurement, and a quantum-secured communication.

Preferably, the verification artifact comprises a state indicator that validates a communication as one of: human-authored communication, AI-assisted communication, and AI-generated communication under authorization.

Preferably, communications validated as AI-generated under authorization comprise a cryptographic reference to a human authorization event invoking AI-generation of the AI-generated communication under authorization, wherein the human authorization event encodes the identity anchor of the verified human identity.

Preferably, the AI-generated communication under authorization is produced using a user-specific communication style model that is accessible only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, a modification to the outbound communications subsequent to generation of the verification artifact invalidates the verification artifact.

Preferably, the system further comprises a receiver layer comprising a public verification protocol enabling a receiving system to receive the outbound communications and validate the verification artifact against the public identity record to confirm authenticity of the outbound communications.

Preferably, an artifact verification failure resulting from invalidation of the verification artifact is recorded in an immutable audit log within a receiver layer.

Preferably, artifact verification failures recorded in the immutable audit log serve as deterministic triggers for engagement of a countermeasure authentication system configured to present at least one deceptive verification pathway to an originating source of the artifact verification failures.

Preferably, artifact verification failures are aggregated across a plurality of communication events by an attacker attribution module.

Preferably, upon exceeding a threshold of artifact verification failures, a deceptive response is communicated to an originating source of digital communications that elicited the artifact verification failures, wherein the deceptive response appears as a successful delivery and returns at least one of false intelligence and corrupted intelligence to the originating source.

Preferably, a receiver authenticator application operating on the receiving system operates as a persistent background verification layer and rejects communications lacking the verification artifact validated against the public identity record.

Preferably, the receiver authenticator application receives a state indicator encoded in the verification artifact and surfaces the state indicator as a filterable signal within a communication interface of the receiver authenticator application.

Preferably, revocation of the signing key when compromised is transmitted as a signed revocation artifact through the signing layer and to the receiving system without dependency on external revocation infrastructure, the signed revocation artifact processed by a receiver authenticator application upon receipt.

Preferably, the signing layer operates within a trusted execution environment of a computing device on which the signing layer is installed, such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to generating the verification artifact and, upon determining that the proposed outbound communication violates a transmission constraint of the permission envelope, performs at least one of: withholding the verification artifact, generating the verification artifact with an enforcement flag, and blocking transmission of the outbound communication.

According to an aspect, a method for authenticating digital communications comprises intercepting, by a signing layer, outbound communications from a verified human identity prior to a transmission of the outbound communications, wherein the verified human identity is registered to a public identity record; binding, by an identity anchor, a signing key to the verified human identity; and producing, by the signing layer, a verification artifact encoding the identity anchor of the verified human identity.

Preferably, the method comprises encoding a state indicator in the verification artifact that validates a communication as one of: human-authored communication, AI-assisted communication, and AI-generated communication under authorization.

Preferably, encoding the state indicator as AI-generated communication under authorization comprises including in the verification artifact a cryptographic reference to a human authorization event invoking AI-generation of the AI-generated communication under authorization, wherein the human authorization event encodes the identity anchor of the verified human identity.

Preferably, producing the AI-generated communication under authorization comprises accessing a user-specific communication style model only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, the method comprises receiving, by a receiver layer, the outbound communications; and validating, by a public verification protocol on the receiver layer, the verification artifact against the public identity record to confirm authenticity of the outbound communications.

Preferably, the method comprises recording an artifact verification failure resulting from an invalidation of the verification artifact in an immutable audit log within the receiver layer.

Preferably, the method comprises, upon recording an artifact verification failure in the immutable audit log, deterministically triggering engagement of a countermeasure authentication system configured to present at least one deceptive verification pathway to an originating source of the artifact verification failure.

Preferably, the method comprises operating a receiver authenticator application on a receiving system as a persistent background verification layer, wherein the receiver authenticator application rejects communications lacking the verification artifact validated against the public identity record.

Preferably, the method comprises receiving, by the receiver authenticator application, a state indicator encoded in the verification artifact and surfacing the state indicator as a filterable signal within a communication interface of the receiver authenticator application.

Preferably, the method comprises transmitting a signed revocation artifact through the signing layer to a receiving system upon compromise of the signing key, without dependency on external revocation infrastructure, wherein the signed revocation artifact is processed by a receiver authenticator application upon receipt.

Preferably, intercepting outbound communications comprises operating the signing layer as a discrete application installed on a computing device without requiring platform-level, device-level, or carrier-level integration, and validating the verification artifact comprises executing the public verification protocol by a receiver-side verification application separately installed on a computing device.

Preferably, intercepting outbound communications and producing the verification artifact each comprise operating within a trusted execution environment of a computing device such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to producing the verification artifact and, upon determining that the proposed outbound communication violates a transmission constraint of the permission envelope, performs at least one of: withholding the verification artifact, producing the verification artifact with an enforcement flag, and blocking transmission of the outbound communication.

According to an aspect, a system for authenticating digital communications comprises a sender layer and a receiver layer. The sender layer comprises a signing layer configured to intercept outbound communications from a verified human identity prior to transmission, wherein the verified human identity is registered to a public identity record; an identity anchor that binds a signing key to the verified human identity; and a verification artifact generated by the signing layer, wherein the verification artifact encodes the identity anchor of the verified human identity. The receiver layer comprises a public verification protocol enabling a receiving system to receive the outbound communications and validate the verification artifact against the public identity record to confirm authenticity of the outbound communications.

Preferably, the verification artifact comprises one or more verifiable elements generated using at least one of: a cryptographic method, a post-quantum cryptographic method, a quantum-derived process, a biometric input, and a device-bound credential, wherein validation of the verification artifact is independent of any specific cryptographic scheme and is based on satisfaction of at least one authorization condition associated with the outbound communications.

Preferably, the verification artifact is constrained by at least one of: temporal validity, single-use enforcement, contextual parameters, device association, and communication-state conditions.

Preferably, the verification artifact includes a component derived from a quantum process, comprising at least one of a quantum randomness, a quantum state measurement, and a quantum-secured communication.

Preferably, the identity anchor is established via at least one of a government-issued identity verification, a biometric binding, a device attestation, and a decentralized identity standard.

Preferably, the verification artifact comprises a state indicator that validates a communication as one of: human-authored communication, AI-assisted communication, and AI-generated communication under authorization.

Preferably, communications validated as AI-generated under authorization comprise a cryptographic reference to a human authorization event invoking AI-generation of the AI-generated communication under authorization, wherein the human authorization event encodes the identity anchor of the verified human identity.

Preferably, the AI-generated communication under authorization is produced using a user-specific communication style model that is accessible only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, a modification to the outbound communications subsequent to validation of the verification artifact invalidates the verification artifact.

Preferably, the system comprises an immutable audit log within the receiver layer in which an artifact verification failure resulting from invalidation of the verification artifact is recorded.

Preferably, artifact verification failures recorded in the immutable audit log serve as deterministic triggers for engagement of a countermeasure authentication system configured to present at least one deceptive verification pathway to an originating source of the artifact verification failures.

Preferably, artifact verification failures are aggregated across a plurality of communication events by an attacker attribution module.

Preferably, upon exceeding a threshold of artifact verification failures, a deceptive response is communicated to an originating source of digital communications that elicited the artifact verification failures, wherein the deceptive response appears as a successful delivery and returns at least one of false intelligence and corrupted intelligence to the originating source.

Preferably, a receiver authenticator application operating on the receiving system operates as a persistent background verification layer and rejects communications lacking the verification artifact validated against the public identity record.

Preferably, the receiver authenticator application receives a state indicator encoded in the verification artifact and surfaces the state indicator as a filterable signal within a communication interface of the receiver authenticator application.

Preferably, revocation of the signing key when compromised is transmitted as a signed revocation artifact through the signing layer and to the receiving system without dependency on external revocation infrastructure, wherein the signed revocation artifact is processed by a receiver authenticator application upon receipt.

Preferably, the signing layer is implemented as a discrete application installable on a computing device without requiring platform-level, device-level, or carrier-level integration, and a receiver-side verification application is separately installable on a computing device and configured to execute the public verification protocol.

Preferably, the signing layer operates within a trusted execution environment of a computing device on which the signing layer is installed, such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to generating the verification artifact and, upon determining that the proposed outbound communication violates a transmission constraint of the permission envelope, performs at least one of: withholding the verification artifact, generating the verification artifact with an enforcement flag, and blocking transmission of the outbound communication.

According to an aspect, a method for authenticating digital communications comprises intercepting, by a signing layer, outbound communications from a verified human identity prior to a transmission of the outbound communications, wherein the verified human identity is registered to a public identity record; binding, by an identity anchor, a signing key to the verified human identity; producing, by the signing layer, a verification artifact encoding the identity anchor of the verified human identity; receiving, by a receiver layer, the outbound communications; and validating, by a public verification protocol on the receiver layer, the verification artifact against the public identity record to confirm authenticity of the outbound communications.

Preferably, the verification artifact comprises one or more verifiable elements generated using at least one of: a cryptographic method, a post-quantum cryptographic method, a quantum-derived process, a biometric input, and a device-bound credential, wherein validation of the verification artifact is independent of any specific cryptographic scheme and is based on satisfaction of at least one authorization condition associated with the outbound communications.

Preferably, the verification artifact is constrained by at least one of: temporal validity, single-use enforcement, contextual parameters, device association, and communication-state conditions.

Preferably, the verification artifact includes a component derived from a quantum process, comprising at least one of quantum randomness, a quantum state measurement, and a quantum-secured communication.

Preferably, the method comprises binding the signing key to the verified human identity by establishing the identity anchor via at least one of a government-issued identity verification, a biometric binding, a device attestation, and a decentralized identity standard.

Preferably, the method comprises encoding a state indicator in the verification artifact that validates a communication as one of: human-authored communication, AI-assisted communication, and AI-generated communication under authorization.

Preferably, encoding the state indicator as AI-generated communication under authorization comprises including in the verification artifact a cryptographic reference to a human authorization event invoking AI-generation of the AI-generated communication under authorization, wherein the human authorization event encodes the identity anchor of the verified human identity.

Preferably, producing the AI-generated communication under authorization comprises accessing a user-specific communication style model only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, a modification to the outbound communications subsequent to the validation of the verification artifact invalidates the verification artifact.

Preferably, the method comprises recording an artifact verification failure resulting from an invalidation of the verification artifact in an immutable audit log within the receiver layer.

Preferably, the method comprises, upon recording an artifact verification failure in the immutable audit log, deterministically triggering engagement of a countermeasure authentication system configured to present at least one deceptive verification pathway to an originating source of the artifact verification failure.

Preferably, the method comprises aggregating artifact verification failures across a plurality of communication events by an attacker attribution module.

Preferably, the method comprises, upon exceeding a threshold of artifact verification failures, initiating a deceptive response communicated to an originating source of digital communications that elicited the artifact verification failures, wherein the deceptive response appears as a successful delivery and returns at least one of false intelligence and corrupted intelligence to the originating source.

Preferably, the method comprises operating a receiver authenticator application on a receiving system as a persistent background verification layer, wherein the receiver authenticator application rejects communications lacking the verification artifact validated against the public identity record.

Preferably, the method comprises receiving, by the receiver authenticator application, a state indicator encoded in the verification artifact and surfacing the state indicator as a filterable signal within a communication interface of the receiver authenticator application.

Preferably, the method comprises transmitting a signed revocation artifact through the signing layer to a receiving system upon compromise of the signing key, without dependency on external revocation infrastructure, wherein the signed revocation artifact is processed by a receiver authenticator application upon receipt.

Preferably, intercepting outbound communications comprises operating the signing layer as a discrete application installed on a computing device without requiring platform-level, device-level, or carrier-level integration, and validating the verification artifact comprises executing the public verification protocol by a receiver-side verification application separately installed on a computing device.

Preferably, intercepting outbound communications and producing the verification artifact each comprise operating within a trusted execution environment of a computing device such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to producing the verification artifact and, upon determining that the proposed outbound communication violates a transmission constraint of the permission envelope, performs at least one of: withholding the verification artifact, producing the verification artifact with an enforcement flag, and blocking transmission of the outbound communication.

According to an aspect, a system for authenticating digital communications comprises a signing layer configured to intercept outbound communications from a verified human identity prior to transmission, wherein the verified human identity is registered to a public identity record; an identity anchor binding a signing key to the verified human identity; and a verification artifact generated by the signing layer, wherein the verification artifact encodes the identity anchor of the verified human identity.

Preferably, the verification artifact comprises one or more verifiable elements generated using at least one of: a cryptographic method, a post-quantum cryptographic method, a quantum-derived process, a biometric input, and a device-bound credential, wherein the verification artifact is constructed independently of any specific cryptographic scheme and is based on satisfaction of at least one authorization condition associated with the outbound communications.

Preferably, the verification artifact is constrained by at least one of: temporal validity, single-use enforcement, contextual parameters, device association, and communication-state conditions.

Preferably, the verification artifact includes a component derived from a quantum process, comprising at least one of a quantum randomness, a quantum state measurement, and a quantum-secured communication.

Preferably, the identity anchor is established via at least one of a government-issued identity verification, a biometric binding, a device attestation, and a decentralized identity standard.

Preferably, the verification artifact comprises a state indicator that classifies a communication as one of: human-authored communication, AI-assisted communication, and AI-generated communication under authorization.

Preferably, communications classified as AI-generated under authorization comprise a cryptographic reference to a human authorization event invoking AI-generation of the AI-generated communication under authorization, wherein the human authorization event encodes the identity anchor of the verified human identity.

Preferably, the AI-generated communication under authorization is produced using a user-specific communication style model that is accessible only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, revocation of the signing key when compromised is transmitted as a signed revocation artifact through the signing layer without dependency on external revocation infrastructure.

Preferably, the signing layer is implemented as a discrete application installable on a computing device without requiring platform-level, device-level, or carrier-level integration.

Preferably, the signing layer operates within a trusted execution environment of a computing device on which the signing layer is installed, such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to generating the verification artifact and, upon determining that the proposed outbound communication violates a transmission constraint of the permission envelope, performs at least one of: withholding the verification artifact, generating the verification artifact with an enforcement flag, and blocking transmission of the outbound communication.

According to an aspect, a method for authenticating digital communications comprises intercepting, by a signing layer, outbound communications from a verified human identity prior to a transmission of the outbound communications, wherein the verified human identity is registered to a public identity record; binding, by an identity anchor, a signing key to the verified human identity; and producing, by the signing layer, a verification artifact encoding the identity anchor of the verified human identity.

Preferably, the verification artifact comprises one or more verifiable elements generated using at least one of: a cryptographic method, a post-quantum cryptographic method, a quantum-derived process, a biometric input, and a device-bound credential, wherein the verification artifact is constructed independently of any specific cryptographic scheme and is based on satisfaction of at least one authorization condition associated with the outbound communications.

Preferably, the verification artifact is constrained by at least one of: temporal validity, single-use enforcement, contextual parameters, device association, and communication-state conditions.

Preferably, the verification artifact includes a component derived from a quantum process, comprising at least one of quantum randomness, a quantum state measurement, and a quantum-secured communication.

Preferably, the method comprises binding the signing key to the verified human identity by establishing the identity anchor via at least one of a government-issued identity verification, a biometric binding, a device attestation, and a decentralized identity standard.

Preferably, the method comprises encoding a state indicator in the verification artifact that classifies a communication as one of: human-authored communication, AI-assisted communication, and AI-generated communication under authorization.

Preferably, encoding the state indicator as AI-generated communication under authorization comprises including in the verification artifact a cryptographic reference to a human authorization event invoking AI-generation of the AI-generated communication under authorization, wherein the human authorization event encodes the identity anchor of the verified human identity.

Preferably, producing the AI-generated communication under authorization comprises accessing a user-specific communication style model only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

Preferably, the method comprises transmitting a signed revocation artifact through the signing layer upon compromise of the signing key, without dependency on external revocation infrastructure.

Preferably, intercepting outbound communications comprises operating the signing layer as a discrete application installed on a computing device without requiring platform-level, device-level, or carrier-level integration.

Preferably, intercepting outbound communications and producing the verification artifact each comprise operating within a trusted execution environment of a computing device such that verification artifact generation is isolated from an application layer of the computing device and inaccessible to unauthorized software.

Preferably, the verification artifact further encodes a permission envelope specifying one or more transmission constraints applicable to the outbound communication, wherein the signing layer evaluates the permission envelope prior to producing the verification artifact and, upon determining that the proposed outbound communication violates a transmission constraint of the permission envelope, performs at least one of: withholding the verification artifact, producing the verification artifact with an enforcement flag, and blocking transmission of the outbound communication.

### BRIEF DESCRIPTION OF THE DRAWINGS

The same reference number represents the same element on all drawings. It should be understood that the drawings are not necessarily to scale.

FIG. 1 shows a system for authenticating digital communications, in accordance with a non-limiting embodiment of the disclosed concept.

FIG. 2 shows a method for authenticating digital communications, in accordance with a non-limiting embodiment of the disclosed concept.

FIG. 3 is a schematic of an authorization system, shown as employed with a user device and a backend server, in accordance with one non-limiting embodiment of the disclosed concept.

FIG. 4 is a schematic view of an authority binding system for a digital document, shown as employed with the digital document in simplified form, in accordance with one non-limiting embodiment of the disclosed concept.

FIG. 5 shows a deterministic control system, in accordance with one non-limiting embodiment of the disclosed concept.

FIG. 6 shows a detailed view of an execution gate mechanism for the deterministic control system 502 of FIG. 5.

FIG. 7 shows a simplified view of a conditioning system, shown with at least one AI model in dashed line drawing to denote that the AI model may not be part of the conditioning system, and shown with execution of an exchange of an autonomous AI agent in dashed line drawing to denote that the execution may be conditional, in accordance with one non-limiting embodiment of the disclosed concept.

FIG. 8 shows a computer-implemented conditioning method that may be executed by the conditioning system 802 of FIG. 7, shown with optional method steps in dashed line drawing.

FIG. 9 shows a system including the systems of FIGS. 5 and 8 together with an authorization system employing the systems of FIGS. 3 and 4, in accordance with one non-limiting embodiment of the disclosed concept.

FIG. 10 shows a simplified view of a countermeasure AI authentication system for detecting and defeating an automated artificial intelligence bypass attempt, in accordance with one non-limiting embodiment of the disclosed concept.

FIG. 11 shows a system including the systems of FIGS. 9 and 10, in accordance with one non-limiting embodiment of the disclosed concept.

FIG. 12 shows a computer-implemented method for detecting and defeating an automated AI bypass attempt, in accordance with one non-limiting embodiment of the disclosed concept.

### DETAILED DESCRIPTION

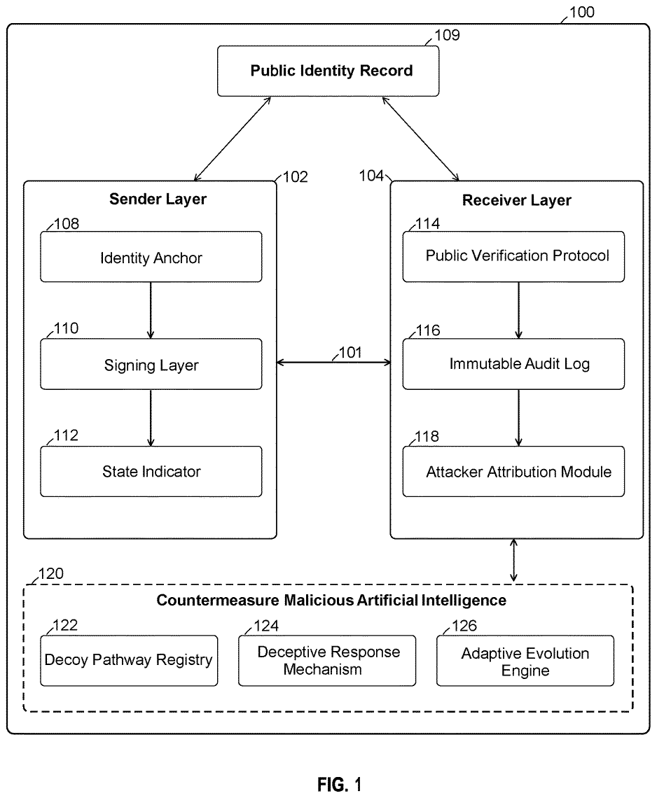

FIG. 1-12 and the following description depict specific examples to teach those skilled in the art how to make and use the best mode of the embodiments. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the present system and method. As a result, the embodiments described below are not limited to the specific examples described below.

The present invention relates to a system 100 for authenticating digital communications. The system 100 intercepts outbound communications from a verified human identity prior to transmission, generates a cryptographic artifact encoding provenance data associated with that identity, and delivers the artifact with the communication for validation by a receiving system. The signing layer 110 operates at or below the application layer of the computing device and intercepts outbound communications across all communication channels 101 from that device irrespective of which application or service originates the communication, without requiring platform-level, device-level, or carrier-level integration.

Existing authentication protocols do not verify that a digital communication originated from a specific human being sending from a specific enrolled device. DomainKeys Identified Mail (DKIM), as specified in Request for Comments 6376 published by the Internet Engineering Task Force (IETF), signs outbound email on behalf of a domain using a server-side key; any authorized user of that domain's mail infrastructure can produce a valid DKIM signature, and no individual human identity or device binding is established. Secure Telephone Identity Revisited/Signature-based Handling of Asserted Information Using Tokens (STIR/SHAKEN) authenticates telephone calls at the carrier level and does not extend to other communication channels. Secure/Multipurpose Internet Mail Extensions (S/MIME) and Pretty Good Privacy (PGP) provide message-level signing limited to electronic mail and require prior key exchange between parties. No existing protocol encodes whether a given text communication was authored by a human, composed with AI assistance, or generated entirely by an AI system acting under human authorization; the Coalition for Content Provenance and Authenticity (C2PA) standard provides content provenance for image and video media but does not address text-based communications.

The system 100 is distinguished from DKIM on four independent grounds. First, the identity anchor 108 binds the signing key to a specific verified human identity; DKIM has no individual human identity binding. Second, the signing key is bound to a specific enrolled device; DKIM has no device enrollment. Third, the signing layer 110 encodes AI-assistance state in every artifact via the state indicator 112; DKIM has no AI-assistance state encoding. Fourth, the receiver layer 104 requires a registered receiver authenticator application as an architectural enforcement mechanism that rejects communications lacking a valid artifact; DKIM has no receiver-side authenticator requirement.

With reference to FIG. 1, the system 100 comprises a sender layer 102 and a receiver layer 104. The sender layer 102 includes an identity anchor 108, a signing layer 110, and a state indicator 112. The receiver layer 104 includes a public verification protocol 114. In some embodiments, the receiver layer 104 further includes an immutable audit log 116 in which artifact verification failures are recorded, an attacker attribution module 118 that aggregates failure records across a plurality of communication events, and a Countermeasure Malicious Artificial Intelligence (CMAI) system 120 comprising, among other architecture, a decoy pathway registry 122, a deceptive response mechanism 124, and an adaptive evolution engine 126. The verified human identity is registered to a public identity record 109 enabling any receiving system to receive the outbound communications and validate the cryptographic artifact without requiring a prior relationship with the sender. In some embodiments, only a sender layer 102 is present.

The identity anchor 108 binds a signing key to a verified human identity. This binding is the foundational distinction between the present invention and prior art domain-level signing architectures. The identity anchor 108 is established at the level of the individual human being and bound to the specific computing device on which the signing layer 110 is installed. The signing key generated from the identity anchor 108 is therefore personal to one verified human identity on one enrolled device, and cannot be produced by a domain server, a mail relay, or any system other than the enrolled device of the verified identity owner.

In some embodiments, the identity anchor 108 is established via government-issued identity verification, wherein the identity verification process presents and validates a government-issued identity document associated with a real human being and the signing key is bound to that verified identity. In some embodiments, the identity anchor 108 is established via biometric binding, wherein one or more biometric participations of the identity owner are captured and associated with the signing key such that subsequent signing operations require biometric confirmation from the enrolled identity owner. In some embodiments, the identity anchor 108 is established via device attestation leveraging existing secure enclave infrastructure of the computing device, wherein the hardware-backed key store of the enrolled device generates and retains the signing key within its trusted execution environment, binding the key to that physical device. In some embodiments, the identity anchor 108 is established via a decentralized identity standard, such that the identity binding is recorded on a decentralized identity ledger accessible without reliance on a central identity authority. The identity anchor 108 may be established through any one or combination of these modalities.

The verified human identity is registered to a publicly accessible public identity record 109. This public identity record 109 enables any receiving system to validate the cryptographic artifact produced by the signing layer 110 against the registered public key of the sender, without requiring a prior relationship with the sender and without contacting any intermediary or identity authority at the time of validation. The public identity record 109 is the verification substrate for the public verification protocol 114, as further described herein.

The identity anchor 108 is related to the device-bound human authorization architecture of U.S. patent application Ser. No. 19/461,799 (HAP) and U.S. patent application Ser. No. 19/455,887 (AIAP), incorporated herein by reference, wherein a live human authorization event on a specific enrolled device is required as a precondition for issuing a cryptographic authorization artifact. The identity anchor 108 of the present invention extends this device-bound identity principle to the outbound communication layer, such that every signed communication carries structural proof that it originated from the enrolled device of the verified identity owner.

The signing layer 110 is configured to intercept outbound communications from a verified human identity prior to transmission. The signing layer 110 operates at or below the application layer of the computing device, functioning as a middleware component, a plugin, or an OS-level interception layer. The signing layer 110 intercepts communications across all digital channels before they leave the device, operating transparently beneath the user's existing communication applications without requiring modification to those applications or to the platforms they connect to.

The channel-agnostic interception capability of the signing layer 110 is an architectural consequence of its position in the software stack. By operating below the application layer, the signing layer 110 intercepts all outbound network-bound communications regardless of whether they originate from an email client, an SMS application, an instant messaging application, a social media application, a legal document platform, or any other communication software installed on the device. This is architecturally distinct from plugin-based or application-specific signing solutions, which operate within a specific application and therefore cannot provide uniform coverage across all channels from a single installation.

In some embodiments, the signing layer 110 is implemented as a discrete downloadable application installable on a computing device without requiring platform-level, device-level, or carrier-level integration. In some embodiments, both the signing layer 110 on the sender side and a receiver-side verification application on the receiver side are installable as standalone applications. This enables end-to-end verified communication between two parties using only their respective application installations, without requiring any modification of underlying platform infrastructure, carrier networks, or operating system components. This standalone application embodiment distinguishes the present invention from carrier-layer solutions such as STIR/SHAKEN, which require carrier-side infrastructure implementation, and from server-side solutions such as DKIM, which require mail server configuration and are not deployable as standalone device applications. It will be understood that embodiments of applications also include implementations via hardware or at the operating system-level.

In some embodiments, the signing layer 110 operates within a trusted execution environment of the computing device on which the signing layer 110 is installed, such that the cryptographic artifact generation is isolated from the application layer of the computing device and is inaccessible to unauthorized software.

The signing layer 110 is configured to produce a cryptographic artifact encoding the identity anchor 108. The cryptographic artifact is a tamper-evident artifact that constitutes a provenance record attached to the outbound communication at the time of signing. The cryptographic artifact encodes the identity anchor 108, a timestamp of the signing event, a device attestation confirming that the artifact was produced on the enrolled device bound to the identity anchor 108, and a state indicator 112 recording the AI-assistance state of the communication at the time of signing.

The cryptographic artifact is generated by the signing layer 110 using the signing key bound to the identity anchor 108. Because the signing key is held within the enrolled device and bound to the verified human identity, the cryptographic artifact constitutes structural proof that the communication was authorized and signed by the verified identity owner on the enrolled device at the recorded timestamp. Any receiving system that has access to the corresponding public key registered in the public identity record 109 may independently validate this proof without contacting the sender or any intermediary.

The state indicator 112 encoded within the cryptographic artifact records which of three AI-assistance states was present at the time of signing. The three states are: (1) human-authored, indicating that the communication was written by the verified human identity with no AI involvement; (2) AI-assisted, indicating human primary authorship with AI editing or suggestion incorporated; and (3) AI-generated under authorization, indicating that the communication was generated by an AI system under a cryptographically verified human authorization event issued by the identity owner. Other states or combinations of states are also considered in embodiments.

The state indicator 112 is encoded at the time the cryptographic artifact is generated by the signing layer 110 and is part of the signed artifact payload. The state indicator 112 is therefore tamper-evident. Because the cryptographic artifact is signed using the signing key bound to the identity anchor 108, any modification to the contents of the artifact after signing, including any modification to the state indicator 112, will invalidate the cryptographic artifact. A receiving system executing the public verification protocol 114 will detect the invalidation and report a verification failure.

More broadly, any modification to the communication subsequent to validation of the cryptographic artifact invalidates the cryptographic artifact. This integrity guarantee applies to the full payload of the communication, not only to the state indicator 112. If any portion of the communication is altered after the artifact is generated by the signing layer 110, the resulting mismatch between the signed artifact and the modified communication content will be detected by the public verification protocol 114 as a verification failure. This property provides a structural, cryptographically enforced guarantee of content integrity from the point of signing through delivery.

The present embodiments therefore provide AI-assistance state encoding in outbound communications. The state indicator 112 of the present embodiments encodes AI-assistance states for a plurality of communication types with tamper-evident cryptographic verification. The state indicator 112 enables recipients and downstream systems to distinguish with certainty between communications that were human-authored, AI-assisted, and AI-generated under authorization, and to verify that the declared state has not been altered since signing.

When the state indicator 112 records an AI-generated under authorization state, the cryptographic artifact produced by the signing layer 110 includes a cryptographic reference to the specific human authorization event that permitted AI invocation of the communication. The human authorization event is a signed record encoding the identity anchor 108 of the verified human identity, the scope of the authorization, and the biometric or multi-factor authentication verification event that triggered it.

This architecture creates a cryptographically verifiable chain of provenance from every AI-generated communication back to the specific human consent event that authorized its production. Every element of the chain is cryptographically bound: the authorization event encodes the identity anchor 108, the identity anchor 108 is bound to the signing key, the signing key produces the cryptographic artifact, and the cryptographic artifact is validated against the public identity record 109. A receiving system executing the public verification protocol 114 therefore has access to the full provenance chain from the received communication back to the human authorization event, without requiring any direct contact with the sender.

Thus, no AI-generated communication can carry a valid cryptographic artifact unless a valid authorization event exists in the chain. A communication purporting to be AI-generated under authorization but lacking a valid authorization event reference will fail validation at the public verification protocol 114 and will be recorded as a verification failure in the immutable audit log 116. This structural requirement eliminates an AI system issuing communications under a false claim of human authorization.

This authorization event linking architecture is structurally related to the real-time digital authorization artifact architecture described in U.S. patent application Ser. No. 19/455,887 (AIAP) and U.S. patent application Ser. No. 19/461,799 (HAP), incorporated herein by reference. In those related applications, a cryptographic module generates a time-bound, device-bound, non-replayable real-time digital authorization artifact based on a live human authorization event, and the real-time digital authorization artifact is consumed as a prerequisite for an action, including without limitation an invocation of an AI system. The authorization event reference encoded in the cryptographic artifact of the present invention provides a durable, verifiable link to the authorization event that conditioned AI invocation of the communication, enabling the recipient to independently verify that the required human consent was present at the time the AI-generated content was produced.

The receiver layer 104 comprises a public verification protocol 114 enabling a receiving system to receive the outbound communications and validate the cryptographic artifact against a public identity record 109 to confirm authenticity of the outbound communications. The public identity record 109 is the publicly accessible record to which the verified human identity is registered. Any receiving system may validate the cryptographic artifact against the public identity record 109 without requiring a prior relationship with the sender and without contacting the sender at the time of validation. The public verification protocol 114 confirms origin authenticity, content integrity, and the AI-assistance state recorded in the state indicator 112.

The public verification protocol 114 is executable by any receiving system that has access to the public identity record 109, including without limitation the receiver authenticator application described below, enterprise mail filtering systems, legal document management platforms, and any downstream verification infrastructure operating on received communications. The open, public nature of the public identity record 109 ensures that the verification capability is not gatekept by the system 100 or by any intermediary.

In some embodiments, a receiver authenticator application operates on the receiving system as a persistent background verification layer. The receiver authenticator application is installed once on the receiving system as a downloadable application and thereafter operates continuously in the background, automatically executing the public verification protocol 114 against every incoming communication that presents a cryptographic artifact from an enrolled sender. The receiver authenticator application rejects communications lacking a cryptographic artifact validated against the public identity record 109. Communications lacking a valid artifact are not delivered to the receiver. In some embodiments, this is an architectural requirement of the system 100, not a configurable user preference.

The receiver authenticator application separately installs on the receiving system without requiring platform-level or carrier-level integration on the receiver side, in the same manner as the signing layer 110 installs on the sender side. This symmetry enables end-to-end verified communication between two parties through only their respective application installations.

The receiver authenticator application also receives the state indicator 112 encoded in the cryptographic artifact and surfaces the state indicator 112 as a filterable signal within the communication interface of the receiver authenticator application. The receiver may filter, flag, or prioritize incoming communications based on whether they were human-authored, AI-assisted, or AI-generated under authorization. This capability enables institutional and individual recipients to implement communication policies based on AI-assistance state, including for example a policy requiring human-authored communications for high-stakes correspondence categories, or a policy flagging AI-generated communications for additional review before action is taken.

Thus, embodiments provide communication protocols having a mandatory receiver-side authenticator that structurally enforces rejection of communications lacking a valid human identity artifact. The receiver authenticator application of the present invention closes gaps by providing a receiver-side enforcement mechanism that applies uniformly across all digital channels and enforces rejection as an architectural property at the individual recipient level, as opposed to a carrier-level or domain-level enforcement mechanism, and creates a receiver-side enforcement mechanism that rejects communications at the individual recipient level based on the absence of a human identity artifact.

In some embodiments, the receiver layer 104 of the system 100 maintains an immutable audit log 116. The immutable audit log 116 is located within the receiver layer 104 because artifact verification failures are detected at the receiving end when the receiver authenticator application executes the public verification protocol 114 against an inbound communication and the validation fails. Every such artifact verification failure is recorded as an entry in the immutable audit log 116. Each entry in the immutable audit log 116 comprises the timestamp of the failed verification event, the device identifier of the sending device associated with the failed artifact, the identity anchor 108 of the claimed sender as presented in the failed artifact, and the nature of the failure indicating the specific reason the artifact could not be validated.

The immutable audit log 116 is cryptographically sealed to prevent tampering or retroactive modification of failure records. In some embodiments, the immutable audit log 116 is structured in accordance with the temporal state record architecture described in U.S. patent application Ser. No. 19/534,902 (Time File), incorporated herein by reference, wherein authoritative state transitions are bound to time coordinates such that the time coordinate is a structural element of the record rather than metadata, and mutability of the historical record is structurally enforced and terminated rather than socially inferred. The immutable audit log 116 serves as a forensic record of unauthorized communication attempts and as a device compromise signal for the enrolled receiver.

In some embodiments, the immutable audit log 116 achieves immutability through cryptographic hash chaining, wherein each entry written to the immutable audit log 116 incorporates a hash of the preceding entry into its signed payload, such that any alteration of a historical record invalidates the hash chain from that point forward and is detectable by any party that recomputes the chain. In some embodiments, the immutable audit log 116 is written to an append-only data store in which the storage mechanism enforces that entries may be added but not modified or removed, and in which write access to existing entries is denied at the storage layer rather than enforced by application-level access controls alone. In some embodiments, the immutable audit log 116 is replicated across a plurality of independent nodes such that no single party possesses the ability to modify the complete record, and any divergence between replicas is detectable as evidence of tampering. These mechanisms may be employed individually or in combination with the cryptographic sealing and time-coordinate binding described above. The foregoing mechanisms may be employed individually or in any combination with the cryptographic sealing and time-coordinate binding described above, and it will be appreciated by those skilled in the art that other mechanisms for achieving immutability of a log or record are contemplated and may be substituted or combined without departing from the scope of the present invention.

Artifact verification failures arise from one or more of the following conditions: the cryptographic artifact presented with an inbound communication cannot be validated against the public identity record 109 because the presented artifact was not produced by the signing key corresponding to the claimed identity anchor 108; the communication has been modified subsequent to signing such that the content no longer matches the signed artifact payload; the state indicator 112 or authorization event reference has been altered after signing; or the inbound communication presents no cryptographic artifact at all, indicating that it did not originate from an enrolled sender. In each case, the failure is recorded in the immutable audit log 116 with the details specified above.

In some embodiments, artifact verification failures are aggregated across a plurality of communication events by the attacker attribution module 118. The aggregated failure records stored in the immutable audit log 116 are analyzed for common origin devices, common identity anchors presented in failed artifacts, common failure types, and temporal signatures across failure events. This analysis generates a pattern-based attacker profile over time. Repeated failure patterns from a common origin constitute an attacker attribution record enabling identification, tracking, and attribution of unauthorized communication attempts across the network. The attacker profile accumulates evidence from each successive failure event, increasing attribution confidence with each recorded incident.

In some embodiments, when a threshold of artifact verification failures from the same originating source has been exceeded, and subject to classification of the originating source as exhibiting characteristics of a malicious actor, and subject to explicit human authorization, the system 100 initiates a deceptive response communicated to the originating source. The deceptive response is designed to appear as a successful delivery while returning false intelligence or corrupted intelligence, or both, to the originating source. The three structural prerequisites for activation of the deceptive response are the threshold of repeated failures from the same origin, the classification determination that the origin exhibits characteristics of a malicious actor, and the explicit human authorization of the deceptive response. In some embodiments, these three prerequisites are architectural requirements of the system 100 and are not configurable features. They serve as the liability protection framework built into the architecture, ensuring that the deceptive response is activated only when the evidentiary threshold, the malicious actor classification, and affirmative human consent are all satisfied simultaneously.

The deceptive response mechanism 124 of the present invention is implemented by the CMAI system 120 and described in further detail below with reference to FIG. 10. The CMAI system 120 comprises a stochastic routing module 1110 that dynamically alters internal verification pathway architecture on a per-session basis, a decoy pathway registry 122 that maintains non-functional decoy verification pathways reachable only through systematic state-space exploration behavior characteristic of automated AI probing, a detection and forensic logging system 1140 that generates tamper-evident covert forensic detection records upon decoy traversal, and an adaptive evolution engine 126 that reads from an attack log 1150 and adaptively evolves routing parameters and decoy configurations in response to accumulated probe behavior patterns.

In some embodiments, the immutable audit log 116 of the present invention serves as a deterministic trigger for activation of the CMAI system 120. The failure records aggregated in the immutable audit log 116 provide the structured probe intelligence enabling the CMAI system 120 to classify the originating source and activate the appropriate deceptive response mechanism 124. The audit log entries generated by the system 100 correspond structurally to the structured probe behavior records stored in the attack log 1150 (FIG. 10)of the CMAI system 120.

In some embodiments, the signing layer 110 operates within a trusted execution environment of the computing device on which the signing layer 110 is installed, such that the cryptographic artifact generation is isolated from the application layer of the computing device and is inaccessible to unauthorized software. A trusted execution environment, also referred to as a secure enclave, is a hardware-isolated processing environment present in modern computing devices that provides a protected execution context separate from the main operating system and application layer. Examples of trusted execution environment implementations include hardware-backed key stores, secure enclaves, Trusted Platform Modules (TPM), and Trusted Execution Environments (TEE) in the sense used in mobile and desktop computing architectures.

Operation of the signing layer 110 within the trusted execution environment addresses application-layer malware threats that cannot be defeated by application-level security measures. One class of such threats is exemplified by the Triada Trojan distributed through compromised application packages, which installs itself inside communication applications and intercepts message content before encryption or after decryption at the application layer. Because the Triada Trojan class of malware operates at the application layer, it is positioned between the user's communication intent and the encryption performed by the application, and can therefore read, modify, or suppress messages before they are secured. By operating within the trusted execution environment, the signing layer 110 in this embodiment is isolated from the application layer and cannot be intercepted, read, modified, or suppressed by malware operating at the application layer. The artifact generation process therefore cannot be compromised by application-layer malware regardless of whether such malware is present on the device.

In some embodiments, the signing key bound to the identity anchor 108 is generated and retained within the trusted execution environment and is never exposed to the application layer or the operating system. The signing layer 110 produces the cryptographic artifact within the trusted execution environment using the protected signing key. The resulting artifact is signed in hardware, in the sense that the signing operation occurs within the hardware-isolated environment. This provides a hardware-backed provenance guarantee that the artifact was produced by the enrolled identity on the enrolled device.

In some embodiments, revocation of the signing key when compromised is transmitted as a signed revocation artifact through the signing layer 110 and to the receiving system without dependency on external revocation infrastructure. The signed revocation artifact is generated by the signing layer 110 and transmitted through the existing sender and receiver infrastructure of the system 100. The signed revocation artifact is processed by the receiver authenticator application upon receipt, which updates its validation state to treat the revoked signing key as invalid for all subsequent artifact validations.

This self-contained revocation architecture requires no certificate authority, no Online Certificate Status Protocol (OCSP) responder, no Certificate Revocation List (CRL) distribution point, and no certificate transparency log. The signed revocation artifact is transmitted through the same channel as normal signed communications and is processed by the same receiver authenticator application that processes normal artifact validations. Revocation is therefore self-contained within the system 100 and available as long as the sender and receiver infrastructure of the system 100 remains operational.

This architecture is distinct from all existing Public Key Infrastructure (PKI) revocation methods. In existing PKI architectures, revocation requires coordination with external certificate authorities or reliance on revocation status distribution infrastructure such as OCSP responders or CRL distribution points, each of which must be continuously maintained and queried by relying parties. The availability of revocation status in existing PKI architectures is therefore contingent on the availability of third-party infrastructure external to the communicating parties. The self-contained revocation architecture of the present invention eliminates all such third-party dependencies, ensuring that revocation is a bilateral operation between the signing identity and the enrolled receivers, mediated by the existing infrastructure of the system 100.

In some embodiments, the AI-generated communication is produced using a user-specific communication style model that is accessible only under authenticated authorization by the identity owner. The style model is a protected asset encoding the communication patterns and stylistic identity of a specific verified human being. Invocation of the style model requires presentation of a valid authorization artifact satisfying the requirements of the identity anchor 108 of the style model owner. No AI system may invoke the style model without a valid authorization artifact issued under the identity anchor 108 of the enrolled owner.

The style model encodes relational variation, meaning distinct communication styles derived from passive observation of the user's outbound communications across different recipient categories. The style model learns from the historical pattern of the identity owner's actual communications with members of different recipient categories and encodes the stylistic, structural, and tonal characteristics that distinguish the user's communications to, for example, professional recipients from those to personal contacts, or to institutional correspondents from those to close associates. This relational variation encoding is a learned asset that is specific to the individual verified human identity and is not reproducible without access to that individual's communication history.

Correspondence generated using the style model carries a cryptographic artifact produced by the signing layer 110. The cryptographic artifact encodes the style model invocation event, the authorization event that permitted invocation under the identity anchor 108 of the style model owner, and the identity anchor 108 itself. A recipient validating the cryptographic artifact via the public verification protocol 114 is therefore able to confirm that the correspondence was AI-generated under authorization by the named identity, that the specific style model associated with that identity was invoked for its production, and that the authorization event satisfying the identity anchor 108 requirements was present at the time of invocation. The correspondence is AI-generated under authorization in the sense of the state indicator 112, and the authorization chain is fully verifiable from the received communication back to the human consent event.

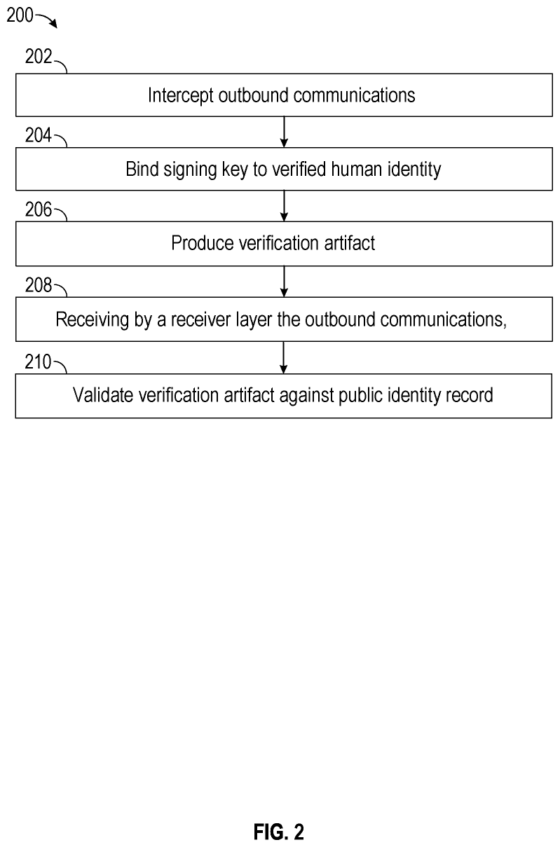

FIG. 2 shows a method 200 for authenticating digital communications. The method 200 may be executed by the system 100 of FIG. 1 and related embodiments described herein. The method 200 comprises a first step 202 of intercepting outbound communications from a verified human identity prior to transmission, a second step 204 of binding a signing key to the verified human identity, a third step 206 of producing a cryptographic artifact encoding the identity anchor 108, a fourth step 208 of receiving, by the receiver layer 104, the outbound communications, and a fifth step 210 of validating the cryptographic artifact against the public identity record 109 on the receiver layer 104 to confirm authenticity of the outbound communications. These steps will be described in further detail below.

At step 202, outbound communications having a verified human identity are intercepted prior to transmission. Interception is performed by the signing layer 110, which operates at or below the application layer of the computing device on which it is installed. The signing layer 110 intercepts communications across all digital channels before they leave the device, irrespective of which application or service is used to originate the communication, without requiring modification to those applications or to the platforms they connect to.

The channel-agnostic interception at step 202 is an architectural consequence of the position of the signing layer 110 in the software stack. By operating below the application layer, the signing layer 110 intercepts all outbound network-bound communications regardless of whether they originate from an email client, an SMS application, an instant messaging application, a social media application, a legal document platform, or any other communication software installed on the device.

In some embodiments, step 202 comprises operating the signing layer 110 as a discrete downloadable application installed on a computing device without requiring platform-level, device-level, or carrier-level integration. In some embodiments, step 202 comprises operating the signing layer 110 within a trusted execution environment of the computing device on which it is installed, such that the cryptographic artifact generation is isolated from the application layer of the computing device and is inaccessible to unauthorized software. This embodiment addresses application-layer malware threats which install inside communication applications and intercept message content before encryption or after decryption at the application layer. Because the signing layer 110 in this embodiment operates within the hardware-isolated trusted execution environment, the interception and signing process at step 202 cannot be suppressed or compromised by malware at the application layer.

At step 204, a signing key is bound to the verified human identity by the identity anchor 108. The binding established at step 204 is personal to one verified human identity on one enrolled device, and the signing key cannot be produced by a domain server, a mail relay, or any system other than the enrolled device of the verified identity owner. The verified human identity is registered to a publicly accessible public identity record 109. This public identity record 109 enables any receiving system to validate the cryptographic artifact produced at step 206 against the registered public key of the sender, without requiring a prior relationship with the sender and without contacting any intermediary or identity authority at the time of validation.

In some embodiments, step 204 comprises establishing the identity anchor 108 via at least one of a government-issued identity verification, a biometric binding, a device attestation, and a decentralized identity standard. In the government-issued identity verification embodiment, the identity verification process presents and validates a government-issued identity document associated with a real human being and the signing key is bound to that verified identity. In the biometric binding embodiment, one or more biometric participations of the identity owner are captured and associated with the signing key such that subsequent signing operations require biometric confirmation from the enrolled identity owner. In the device attestation embodiment, the hardware-backed key store of the enrolled device generates and retains the signing key within its trusted execution environment, binding the key to that physical device. In the decentralized identity standard embodiment, the identity binding is recorded on a decentralized identity ledger accessible without reliance on a central identity authority. The identity anchor 108 may be established through any one or combination of these modalities.

In some embodiments, step 204 further comprises transmitting a signed revocation artifact through the signing layer 110 to the receiving system upon compromise of the signing key, without dependency on external revocation infrastructure. The signed revocation artifact is generated by the signing layer 110 and transmitted through the existing sender and receiver infrastructure of the system 100. The signed revocation artifact is processed by a receiver authenticator application upon receipt, which updates its validation state to treat the revoked signing key as invalid for all subsequent artifact validations. This self-contained revocation architecture requires no certificate authority, no OCSP, no CRL distribution point, and no certificate transparency log.

At step 206, a cryptographic artifact encoding the identity anchor 108 is produced. The cryptographic artifact is a tamper-evident artifact that constitutes a provenance record attached to the outbound communication at the time of signing. The cryptographic artifact produced at step 206 encodes the identity anchor 108, a timestamp of the signing event, a device attestation confirming that the artifact was produced on the enrolled device bound to the identity anchor 108, and a state indicator 112 recording the AI-assistance state of the communication at the time of signing.

In some embodiments, step 206 further comprises encoding a state indicator 112 in the cryptographic artifact that validates the communication as one of: human-authored, indicating that the communication was written by the verified human identity with no AI involvement; AI-assisted, indicating human primary authorship with AI editing or suggestion incorporated; and AI-generated under authorization, indicating that the communication was generated by an AI system under a cryptographically verified human authorization event issued by the identity owner. Other states or combinations of states are also considered in embodiments. The state indicator 112 is encoded at the time the cryptographic artifact is produced at step 206 and is part of the signed artifact payload. Because the cryptographic artifact is signed using the signing key bound at step 204, any modification to the contents of the artifact after signing, including any modification to the state indicator 112, will invalidate the cryptographic artifact.

In some embodiments, step 206 further comprises, when the state indicator 112 records an AI-generated under authorization state, including in the cryptographic artifact a cryptographic reference to a human authorization event invoking AI-generation of the communication. The human authorization event is a signed record encoding the identity anchor 108 of the verified human identity, the scope of the authorization, and the biometric or multi-factor authentication verification event that triggered it. This creates a cryptographically verifiable chain of provenance from the outbound communication back to the specific human consent event that authorized its production. No AI-generated communication can carry a valid cryptographic artifact produced at step 206 unless a valid authorization event exists in the chain.

More broadly, any modification to the communication subsequent to production of the cryptographic artifact at step 206 invalidates the cryptographic artifact. If any portion of the communication is altered after the artifact is produced, the resulting mismatch between the signed artifact and the modified communication content will be detected at step 210 as a verification failure. This property provides a structural, cryptographically enforced guarantee of content integrity from the point of signing through delivery.

In some embodiments, step 206 comprises producing the cryptographic artifact within a trusted execution environment of the computing device, such that the signing operation occurs within the hardware-isolated environment and the signing key bound at step 204 is generated and retained within the trusted execution environment and is not exposed to the application layer or the operating system. This provides a hardware-backed provenance assurance that the artifact was produced by the enrolled identity on the enrolled device.

In some embodiments, step 206 further comprises producing the AI-generated communication using a user-specific communication style model that is accessible only upon presentation of a valid authorization artifact satisfying the requirements of the identity anchor 108 of a style model owner. The style model encodes relational variation comprising distinct communication styles derived from passive observation of outbound communications of the style model owner across a plurality of recipient categories. The cryptographic artifact produced at step 206 for such AI-generated communication encodes a reference to the style model invocation event, the human authorization event, and the identity anchor 108 of the style model owner, such that the authorization chain is fully verifiable from the received communication back to the human consent event.

At step 208, the receiver layer 104 receives the outbound communications. The receiver layer 104 receives every inbound communication that presents a cryptographic artifact from an enrolled sender, and the public verification protocol 114 is executed against the received communications as described at step 210 below. At step 210, the cryptographic artifact produced at step 206 is validated against the public identity record 109 by the public verification protocol 114 on the receiver layer 104 to confirm authenticity of the outbound communications. The public identity record 109 is the publicly accessible record to which the verified human identity is registered. The public verification protocol 114 confirms origin authenticity, content integrity, and the AI-assistance state recorded in the state indicator 112. Any receiving system that has access to the public identity record 109 may execute step 210 without requiring a prior relationship with the sender and without contacting the sender at the time of validation.

An artifact verification failure at step 210 arises from one or more of the following conditions: the cryptographic artifact presented with an inbound communication cannot be validated against the public identity record 109 because the presented artifact was not produced by the signing key corresponding to the claimed identity anchor 108; the communication has been modified subsequent to step 206 such that the content no longer matches the signed artifact payload; the state indicator 112 or authorization event reference has been altered after signing; or the inbound communication presents no cryptographic artifact at all, indicating that it did not originate from an enrolled sender.

In some embodiments, step 210 further comprises operating a receiver authenticator application on the receiving system as a persistent background verification layer, wherein the receiver authenticator application rejects communications lacking the cryptographic artifact validated against the public identity record 109. The receiver authenticator application is installed once on the receiving system as a downloadable application and thereafter operates continuously in the background, automatically executing the public verification protocol 114 against every incoming communication. In some embodiments, this is an architectural requirement of the method 200, not a configurable user preference. In some embodiments, step 210 further comprises receiving, by the receiver authenticator application, the state indicator 112 encoded in the cryptographic artifact and surfacing the state indicator 112 as a filterable signal within a communication interface of the receiver authenticator application, enabling the receiver to filter, flag, or prioritize incoming communications based on whether they were human-authored, AI-assisted, or AI-generated under authorization.

In some embodiments, step 210 further comprises recording an artifact verification failure resulting from invalidation of the cryptographic artifact in an immutable audit log 116 within the receiver layer 104. Each entry recorded in the immutable audit log 116 comprises the timestamp of the failed verification event, the device identifier of the sending device associated with the failed artifact, the identity anchor 108 of the claimed sender as presented in the failed artifact, and the nature of the failure indicating the specific reason the artifact could not be validated. The immutable audit log 116 is cryptographically sealed to prevent tampering or retroactive modification of failure records.

In some embodiments, the immutable audit log 116 maintained at step 210 is structured in accordance with the temporal state record architecture described in U.S. patent application Ser. No. 19/534,902 (Time File), incorporated herein by reference, wherein authoritative state transitions are bound to time coordinates such that the time coordinate is a structural element of the record rather than metadata, and mutability of the historical record is structurally enforced and terminated rather than socially inferred. In some embodiments, the immutable audit log 116 achieves immutability through cryptographic hash chaining, wherein each entry written to the immutable audit log 116 incorporates a hash of the preceding entry into its signed payload, such that any alteration of a historical record invalidates the hash chain from that point forward and is detectable by any party that recomputes the chain. In some embodiments, the immutable audit log 116 is written to an append-only data store in which the storage mechanism enforces that entries may be added but not modified or removed, and in which write access to existing entries is denied at the storage layer rather than enforced by application-level access controls alone. In some embodiments, the immutable audit log 116 is replicated across a plurality of independent nodes such that no single party possesses the ability to modify the complete record, and any divergence between replicas is detectable as evidence of tampering. The foregoing mechanisms may be employed individually or in any combination with the cryptographic sealing and time-coordinate binding described above, and it will be appreciated by those skilled in the art that other mechanisms for achieving immutability of a log or record are contemplated and may be substituted or combined without departing from the scope of the present invention.

In some embodiments, step 210 further comprises aggregating artifact verification failures across a plurality of communication events by the attacker attribution module 118. The aggregated failure records stored in the immutable audit log 116 are analyzed for common origin devices, common identity anchors presented in failed artifacts, common failure types, and temporal signatures across failure events, generating a pattern-based attacker profile over time. In some embodiments, step 210 further comprises, upon exceeding a threshold of artifact verification failures from the same originating source, and subject to classification of the originating source as exhibiting characteristics of a malicious actor, and subject to explicit human authorization, initiating a deceptive response communicated to the originating source. The deceptive response is designed to appear as a successful delivery while returning false intelligence or corrupted intelligence, or both, to the originating source. The three structural prerequisites for activation of the deceptive response, namely the threshold of repeated failures, the malicious actor classification, and the explicit human authorization, are architectural requirements and are not configurable features.

In some embodiments, step 210 comprises executing the public verification protocol 114 by a receiver-side verification application separately installed on a computing device without requiring platform-level or carrier-level integration on the receiver side, in the same manner as the signing layer 110 is installed on the sender side at step 202. This symmetry enables end-to-end verified communication between two parties through only their respective application installations.

In some embodiments, both intercepting the outbound communications at step 202 and producing the cryptographic artifact at step 206 comprise operating within a trusted execution environment of a computing device, such that cryptographic artifact generation is isolated from an application layer of the computing device and inaccessible to unauthorized software. In this embodiment, both the interception operation of step 202 and the artifact production operation of step 206 occur within the hardware-isolated trusted execution environment, such that neither operation can be intercepted, suppressed, or compromised by malware operating at the application layer.

The CMAI system 120 introduced above with reference to FIGS. 1 and 2 is described in additional detail below with reference to FIG. 10. The CMAI system 120 of FIGS. 1 and 2 and of FIG. 10 are the same system. In FIG. 1, the CMAI system is designated as an optional component of the system 100 for authenticating digital communications, with the detailed internal architecture of that system set forth in the description of FIG. 10 using element numbers 1110 (stochastic routing module), 122 (decoy pathway registry), 1130 (verification logic engine), 1140 (detection and forensic logging system), 1150 (attack log), and 126 (adaptive evolution engine). The description of FIG. 10 should therefore be read together with the description of FIGS. 1 and 2 as a unified disclosure of the CMAI system 120. It should be noted that the immutable audit log 116 and the attack log 1150 may be, in some embodiments, the same element, such as a multi-instance implementation of the immutable audit log 116 for verification purposes. In some embodiments, only a single instance of a log is present, such that either the immutable audit log 116 or the attack log 1150 is the only version of an audit log for the present cryptographic verification embodiments in either the system 100 or the CMAI system 120. In some embodiments, the immutable audit log 116 and the attack log 1150 are different logs.

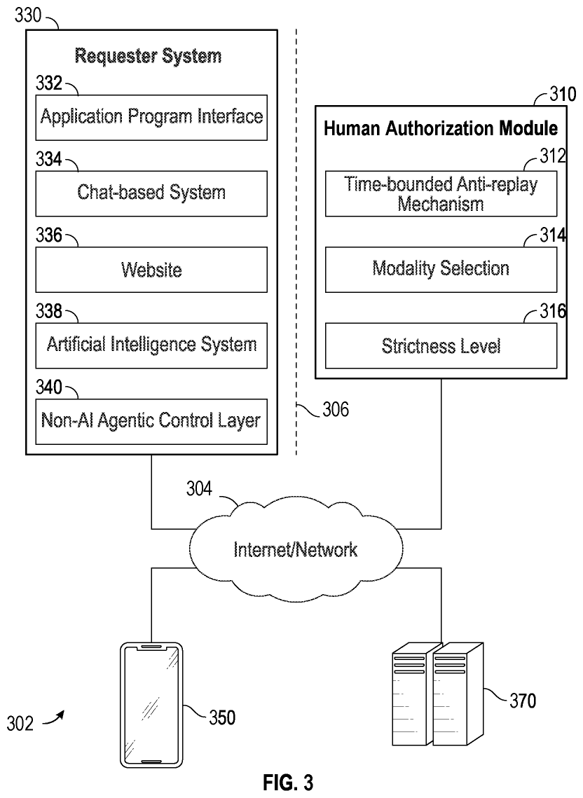

FIG. 3 shows an authorization system 302 as employed with a user device 350 and a backend server 370, in accordance with one non-limiting embodiment of the disclosed concept. The authorization system 302 may include a human authorization module 310 (e.g., without limitation, a hardware-backed key store such as a secure enclave, TPM, and TEE) and a requester system 330, each of which may be communicable over an internet/network 304, and each of which may be architecturally separated from one another. The authorization system 302 may treat human authorization itself as a distinct, enforceable system layer that produces an artifact for downstream consumption.

The human authorization module 310 may be configured to generate a real-time digital authorization artifact based on a live human authorization event and emit the real-time digital authorization artifact. The requester system 330 may be configured to consume the real-time digital authorization artifact as a prerequisite for an action in order to prove that a real human being was present and authorized during a set time window on the user device 350. The real-time digital authorization artifact may be time-bound, non-replayable, bound to the user device 350, and machine-consumable by downstream software systems. The authorization system 302 may use live human presence verification with a number of biometric participations, device-owner confirmation, and time-bounded anti-replay mechanisms. The human authorization module 310 may include a time-bounded anti-replay mechanism 312, and may be architecturally separated from the requester system 330 by an architectural separation boundary 306, such that authorization control may reside entirely within the human authorization module 310 and not the requester system 330.

The requester system 330 may include a plurality of downstream consumer types configured to receive and act upon the real-time digital authorization artifact. In some embodiments, the requester system 330 may interface with one or more of an application program interface 332, a chat-based system 334, a website 336, an artificial intelligence system 338, and a non-AI agentic control layer 340, each of which may be configured to consume the real-time digital authorization artifact as a prerequisite for an authorized action. The human authorization module 310 may further include a modality selection component 314 configured to determine which biometric or authentication modality is presented to the user, and a strictness level component 316 configured to govern the threshold of authentication confidence required before the real-time digital authorization artifact is issued. The modality selection component 314 and the strictness level component 316 may operate within the human authorization module 310 such that authorization control, including the selection of authentication modality and the enforcement of strictness thresholds, resides entirely within the human authorization module 310 and not within the requester system 330 or any of its downstream consumer types.

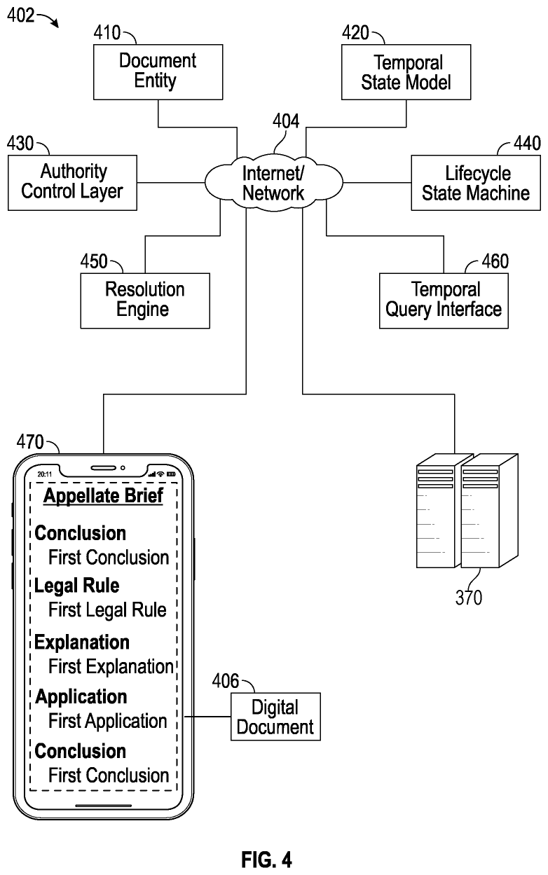

FIG. 4 shows a schematic view of an authority binding system 402 for a digital document 406, in accordance with one non-limiting embodiment of the disclosed concept. The authority binding system 402 may include a document entity 410, a temporal state model 420, an authority control layer 430, a lifecycle state machine 440, a resolution engine 450, and a temporal query interface 460, each of which may be configured to communicate over an internet/network 404. The authority binding system 402 is also shown in FIG. 4 as employed with a user device 470 and the backend server 370, each of which may be configured to communicate with the elements 410, 420, 430, 440, 450, and 460 of the authority binding system 402 over the internet/network 404.

The temporal state model 420 may bind an authoritative state of the digital document 406 to a time output from a clock, such that the time output may be part of a structural model of the digital document 406 rather than merely metadata. The authority control layer 430 may govern the authoritative state by a number of time-bound lifecycle state transitions. The lifecycle state machine 440 may structurally enforce those transitions. The temporal query interface 460 may deterministically resolve requests to access the digital document 406 at any point in time.

The authority binding system 402 may be employed such that authorization artifacts of the authorization system 302 (FIG. 3) may be piped into the authority binding system 402 as triggered entry events. The authorization event and the permanent record of that authorization may thereby become the same atomic event, providing a cryptographically sealed, temporally ordered, and structurally immutable record of every human authorization event. Accordingly, the detection and forensic logging system 1140 of the CMAI system 120 may seal tamper-evident forensic detection records to an immutable ledger of the authority binding system 402.

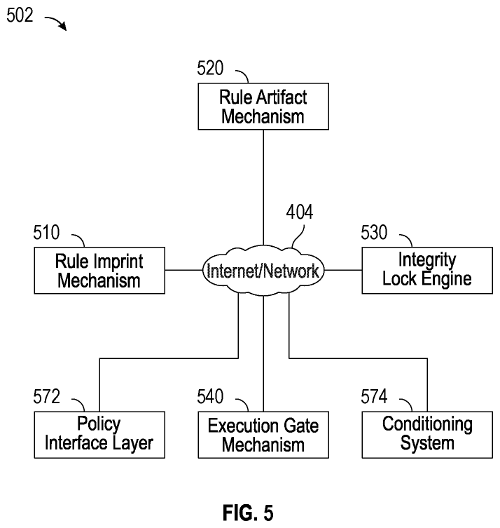

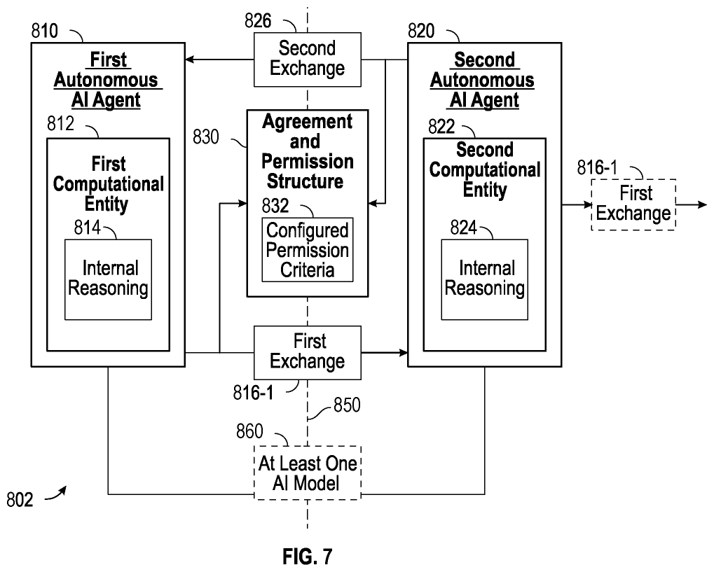

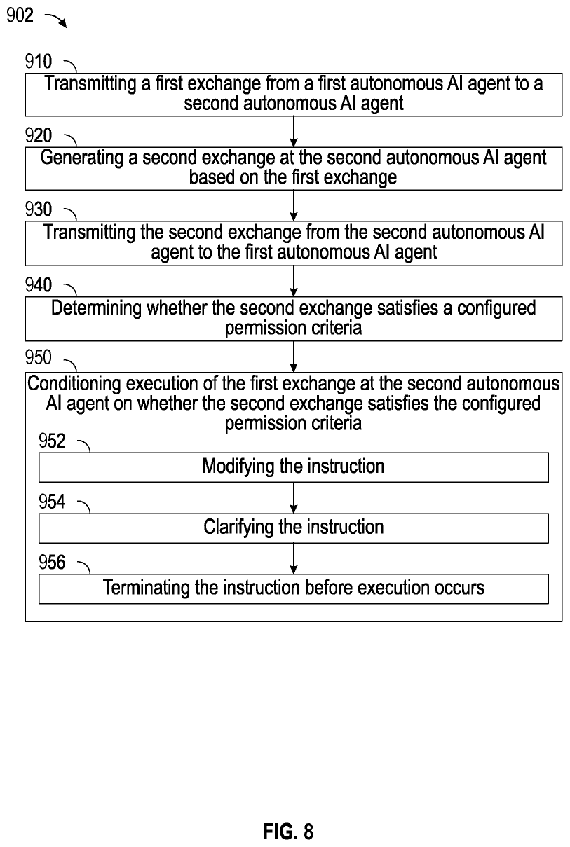

FIG. 5 shows a deterministic control system 502, in accordance with one non-limiting embodiment of the disclosed concept. The deterministic control system 502 may be architected such that it must request and be granted permission before acting, and may not be configured to self-authorize execution. The deterministic control system 502 may include a rule imprint mechanism 510, a rule artifact mechanism 520, an integrity lock engine 530, and an execution gate mechanism 540. In some embodiments, the deterministic control system 502 may further include a policy interface layer 572 configured to allow rule configuration, versioning, and updates among the rule imprint mechanism 510, the rule artifact mechanism 520, the integrity lock engine 530, and the execution gate mechanism 540, while preserving artifact history and preventing silent mutation of active rules. FIG. 5 also shows the conditioning system 802 at element 574 to illustrate the operational relationship between the conditioning system 802 and the deterministic control system 502, wherein agent-to-agent interactions governed by the conditioning system 802 may feed into the execution gate mechanism 540 as a pre-gate layer, as described in further detail below with reference to FIGS. 7 and 8.

The rule imprint mechanism 510 may fix agreed constraints as authoritative rules prior to execution. The rule artifact mechanism 520 may provide a persistent, inspectable representation of those constraints in the form of a rule artifact, which may become the authoritative reference for enforcement. The integrity lock engine 530 may freeze the imprinted rules to prevent modification or reinterpretation. The execution gate mechanism 540 may provide binary runtime enforcement (allow or block) at the execution boundary, requiring a pre-execution authorization decision based on structured action semantics, risk classification, and policy constraints, before any external side effects occur. A core gating decision of the execution gate mechanism 540 may be a structural action irreversibility classifier that operates prior to policy logic, classifying an action as reversible vs. irreversible as a first-pass structural gate. Under degraded conditions including timeout, latency spike, or policy service unavailability, the execution gate mechanism 540 may default to deny or sandbox, and may never default to implicit allow.

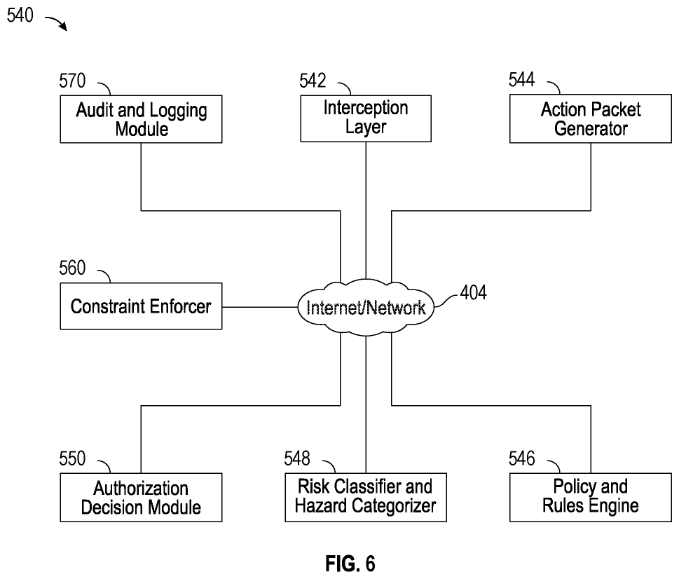

FIG. 6 shows a detailed view of the execution gate mechanism 540, which may include an interception layer 542, an action packet generator 544, a policy and rules engine 546, a risk classifier and hazard categorizer 548, an authorization decision module 550, a constraint enforcer 560, and an optional audit and logging module 570. The interception layer 542 may intercept tool/API calls and prevent direct execution without a gate decision. The action packet generator 544 may convert a raw action instruction into a structured representation comprising action type, target, parameters, and expected side effects. The authorization decision module 550 may return allow/deny/sandbox/escalate/allow-with-constraints. Consumption of the rule artifact may be atomic, such that only one execution may win. If action parameters change after the rule artifact is issued, the rule artifact may become invalid. A modified request may not reuse a prior artifact.

As will be discussed, the execution gate mechanism 540 of the deterministic control system 502 may serve as the deterministic trigger source for engagement of the CMAI system 120. A block event generated by the execution gate mechanism 540, determined by the binary condition of valid artifact present or not, may, in some embodiments, serve as a sole and sufficient trigger for activation of the CMAI system 120, thus requiring no behavioral inference, anomaly scoring, or probabilistic judgment.

FIG. 7 shows a conditioning system 802, which may include a first autonomous AI agent 810, a second autonomous AI agent 820, and an agreement and permission structure 830. The conditioning system 802 may provide a pre-execution handshake between the first and second autonomous AI agents 810,820 in order to prevent silent misinterpretation, compounding autonomous errors, and unintended actions.

The first autonomous AI agent 810 may be configured to transmit a first exchange 816-1 to the second autonomous AI agent 820. The second autonomous AI agent 820 may generate a second exchange 826 based on the first exchange 816-1—a structured semantic interpretation of how it understood the instruction—and transmit the second exchange 826 back to the first autonomous AI agent 810. The agreement and permission structure 830 may determine whether the second exchange 826 satisfies a configured permission criteria 832, and may condition execution of the first exchange 816-1 on that determination. Neither of the autonomous AI agents 810,820 may self-authorize or self-validate; authority may reside in the agreement and permission structure 830, external to the internal reasoning of either agent.

In some embodiments, the first autonomous AI agent 810 may include a first computational entity 812 having a first internal reasoning 814, and the second autonomous AI agent 820 may include a second computational entity 822 having a second internal reasoning 824. The first and second computational entities 812 and 822 may be separated from one another by a boundary 850, which may be at least one of a physical boundary, a network-based boundary, and a logical boundary, depending on deployment. Examples of the boundary 850 include the first and second autonomous AI agents 810 and 820 executing in separate processes, containers, virtual machines, or services, being separated by an application program interface boundary, message queue, middleware layer, or network interface, or being hosted on different physical devices or cloud environments. The first and second autonomous AI agents 810 and 820 may additionally be associated with at least one AI model 860, and the agreement and permission structure 830 may be configured to condition execution of the first exchange 816-1 independent of an authority of the at least one AI model 860. The agreement and permission structure 830 may evaluate communications that traverse the boundary 850 without requiring modification of the first internal reasoning 814 or the second internal reasoning 824, such that authority resides in the agreement and permission structure 830 externally and not within the internal reasoning of either autonomous AI agent.

FIG. 8 shows a computer-implemented method 902 which may be executed by the conditioning system 802 of FIG. 7. In one example, the method 902 may include a first step 910 of transmitting the first exchange 816-1 from the first autonomous AI agent 810 to the second autonomous AI agent 820; a second step 920 of generating the second exchange 826 at the second autonomous AI agent 820 based on the first exchange 816-1; a third step 930 of transmitting the second exchange 826 from the second autonomous AI agent 820 to the first autonomous AI agent 810; a fourth step 940 of determining whether the second exchange 826 satisfies the configured permission criteria 832; and a fifth step 950 of conditioning execution of the first exchange 816-1 at the second autonomous AI agent 820 on whether the second exchange 826 satisfies the configured permission criteria 832. The fifth step 950 may include at least one of a step 952 of modifying the instruction, a step 954 of clarifying the instruction, and a step 956 of terminating the instruction before execution occurs because the second exchange 826 is at least one of rejected and partially incorrect.

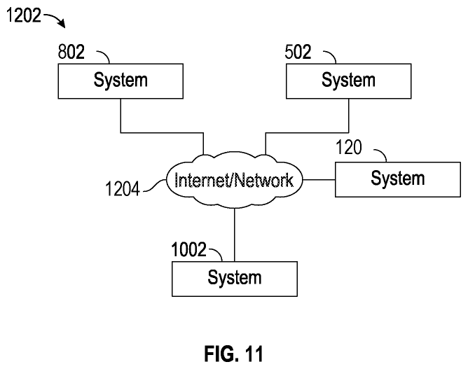

As will be discussed, when the agreement and permission structure 830 rejects an agent-to-agent interpretation handshake, that rejection may serve as a block event triggering engagement of the CMAI system 120 in the system 1202 (FIG. 11), subject to a threshold-based activation condition distinguishing adversarial state-space exploration from ordinary authorized-agent miscommunication.

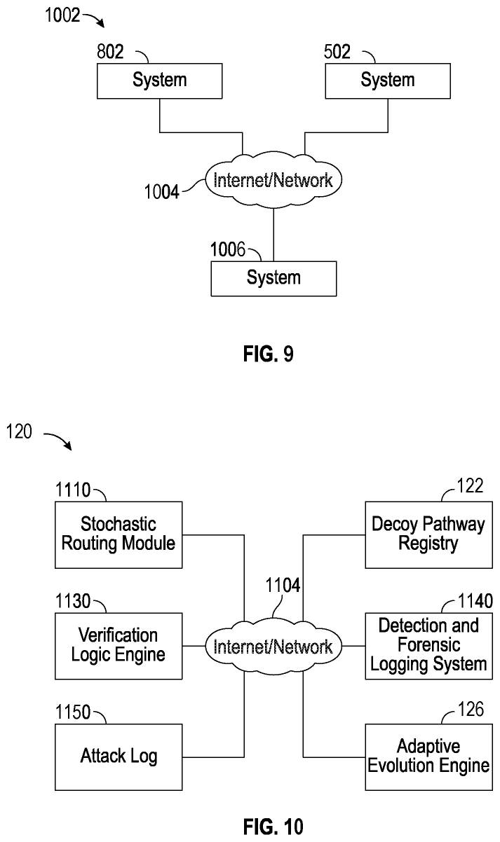

FIG. 9 shows a system 1002 including an authorization system 1006—which incorporates the authorization system 302 (FIG. 3) and the authority binding system 402 (FIG. 4)—together with the deterministic control system 502 (FIG. 5) and the conditioning system 802 (FIG. 7), wherein these systems are communicable over an internet/network 1004.

In the system 1002, the authorization system 302 (FIG. 3) may be a human-gated enforcement layer that requires live human presence for high-stakes actions. The execution gate mechanism 540 (FIG. 5) of the deterministic control system 502 may be an automated runtime enforcement complement that handles a broader range of agent operations that need structural enforcement but do not require a human for every action. Together, these components may form a complete enforcement stack in which neither the human-gated layer nor the automated gate layer permits autonomous self-authorization.

In one example, every enforcement decision (allow or block) of the deterministic control system 502 may simultaneously generate a triggered entry event in the authority binding system 402, such that an authorization artifact check and permanent record of that check may be the same atomic event. An absence of a record in the authority binding system 402 for an event of the deterministic control system 502 may be structural proof that an action bypassed the execution boundary entirely.

Additionally, agent-to-agent interactions governed by the conditioning system 802 may feed into the execution gate mechanism 540 as a pre-gate layer. The confirmed exchange between the first and second autonomous AI agents 810,820 may become an action request that the deterministic control system 502 then evaluates at the execution boundary, ensuring the receiving agent understood the instruction correctly before the deterministic control system 502 enforces whether the action is authorized.

Furthermore, under degraded conditions, the execution gate mechanism 540 (FIG. 5) may default to deny or sandbox and may never default to implicit allow. The system 1002 may thus never fail open for high-stakes actions. Execution authority in the system 1002 may come solely from possessing a valid, current, context-bound artifact at the moment of action—a stolen agent identity may not grant execution rights.

FIG. 10 shows a simplified view of the CMAI system 120 for detecting and defeating an automated AI bypass attempt. In one example, the CMAI system 120 comprises an adaptive evolution engine 126 configured to detect the automated AI bypass attempt; a stochastic routing module 1110 configured to generate a number of internal verification pathway configurations, the stochastic routing module 1110 having a number of routing parameters; a decoy pathway registry 122 configured to store at least one decoy verification pathway; a verification logic engine 1130 configured to execute the number of internal verification pathway configurations by incorporating both a number of functional verification pathways and the at least one decoy verification pathway; a detection and forensic logging system 1140 configured to generate a forensic detection record upon traversal of any one of the at least one decoy verification pathway; and an attack log 1150 configured to store a number of structured probe behavior records derived from a number of decoy traversal events, each record of the number of structured probe behavior records comprising at least one of the number of internal verification pathway configurations. In one example, the adaptive evolution engine 126 may be further configured to defeat the automated AI bypass attempt by both analyzing the number of structured probe behavior records and adaptively updating the number of routing parameters of the stochastic routing module 1110 and the at least one decoy verification pathway. Furthermore, it will be appreciated that the stochastic routing module 1110, the decoy pathway registry 122, the verification logic engine 1130, the detection and forensic logging system 1140, the attack log 1150, and the adaptive evolution engine 126 may each be communicable over an internet/network 1104.

Continuing to refer to FIG. 10, the stochastic routing module 1110 may dynamically alter the internal verification pathway architecture on a per-session basis using a cryptographically seeded non-deterministic routing function, thereby preventing reliable adversarial modeling across sessions. The decoy pathway registry 122 may maintain non-functional decoy verification pathways reachable only through AI systematic state-space exploration, thereby returning adversarial training data poisoning signals upon traversal. The verification logic engine 1130 may execute the per-session verification architecture as configured by the stochastic routing module 1110, incorporating both functional and decoy pathways. The verification logic engine 1130 may be a real-time trigger component.

The detection and forensic logging system 1140 may generate tamper-evident covert forensic detection records upon decoy traversal, sealed to an immutable ledger of an authority binding system (e.g., the authority binding system 402, FIG. 4) and cross-referenced with cryptographic artifact issuance records. The attack log 1150 may provide a structured, queryable probe intelligence corpus distinct from the detection and forensic logging system 1140, recording a complete exploration sequence, behavioral fingerprint, and configuration of the stochastic routing module 1110 for every probe session, thereby serving as a training dataset for the adaptive evolution engine 126. The adaptive evolution engine 126 may read from the attack log 1150, analyze accumulated probe behavior patterns, and use that analysis as a training signal to adaptively evolve routing parameters of the stochastic routing module 1110 and a decoy configuration of the decoy pathway registry 122. The adaptive evolution engine 126 may operate under a dual objective fitness function that simultaneously maximizes probe difficulty and holds human cognitive load constant. In this regard, the system 120 may advantageously become structurally harder to defeat with every probe attempt.

It will also be appreciated that the system 120 may achieve a number of adversarial asymmetry inversion properties. An automated probe must explore the full apparent state space to find an exploitable gap, inevitably encountering decoy pathways in the process. A defender may detect probe activity upon any single decoy traversal event. Stochastic routing may prevent reliable cross-session architectural map construction. Covert detection may eliminate adaptive evasion strategies based on detection feedback. Adversarial training data poisoning may degrade an internal model quality of the probe with each session. The adaptive evolution engine 126 may actively learn from each attack, evolving the system 120 to be increasingly adversarial to observed exploration strategies while remaining frictionless for human users.

Continuing to refer to FIG. 10, existing randomized authentication systems randomize user-facing inputs (e.g., user-facing biometric inputs), whereas the internal backend system 120 itself may be randomized. The verification logic map, pathway sequencing, weighting, and activation state of sub-challenge branches may change per session in the system 120 such that an adversary cannot accumulate reliable intelligence regardless of probe sessions. The pathways of the decoy pathway registry 122 may be integrated into authentication logic and engineered to be reachable only through systematic state-space exploration behavior characteristic of automated AI probing. Detection in this regard may be covert—the traversing entity may receive no signal that detection occurred, thereby eliminating adaptive evasion strategies.

Data poisoning is universally described as an offensive technique. The CMAI system 120 may deploy data poisoning as a structural defense within an authentication system. Decoy pathways may return misleading signals that corrupt the adversary's internal model of the authentication architecture. The attack log 1150 may capture complete exploration sequences, behavioral fingerprints, and configurations of the stochastic routing module 1110 per session, thereby allowing the adaptive evolution engine 126 to identify recurring strategies, classify probe sophistication, and detect coordinated multi-session campaigns.

It will be appreciated that the stochastic routing module 1110 may control the sequencing, weighting, and activation state of verification sub-challenges on a per-session basis using a cryptographically seeded non-deterministic routing function. The stochastic routing module 1110 may vary at least the ordering of biometric verification sub-challenges, the weighting assigned to individual biometric modalities, the timing and presentation characteristics of verification challenges, and the activation state of individual verification pathway branches. The stochastic routing module 1110 may not alter an ultimate biometric presence threshold required for successful authentication. Randomization may operate exclusively on an internal pathway structure such that a legitimate human user may experience interface variation but not a change in the fundamental requirement of demonstrating genuine biometric presence, while an automated probe may observe a different architectural surface in each session, thereby preventing reliable model construction.

It will also be appreciated that the decoy pathway registry 122 may maintain a registry of one or more decoy verification pathways, each: presenting as a potentially valid authentication pathway to an external automated probe performing systematic state-space exploration; not being reachable through authentic human interaction with the presented verification interface under normal operation; not contributing to authentication completion for legitimate users; generating a covert detection event upon traversal without modifying the session outcome detectably; and returning misleading pathway availability signals functioning as adversarial training data poisoning vectors. In some examples, the decoy pathway registry 122 may maintain multiple decoy verification pathways with varying apparent surface characteristics, such that detection of one decoy may not reveal the structure or location of additional decoys.

It will also be appreciated that the verification logic engine 1130 may execute a per-session verification architecture as configured by the stochastic routing module 1110, incorporating both functional verification pathways and decoy verification pathways from the decoy pathway registry 122. The verification logic engine 1130 may present a verification interface to an authenticating entity, may route traversal attempts through a configured pathway architecture, may evaluate authentication outcomes against the required biometric presence threshold, and may signal decoy traversal events to the detection and forensic logging system 1140 and the attack log 1150 in real time.

In some examples, the detection and forensic logging system 1140 may generate a tamper-evident forensic record upon any decoy verification pathway traversal event, sealed to an immutable ledger of an authority binding system (e.g., the authority binding system 402, FIG. 4). In one embodiment, a record of the detection and forensic logging system 1140 may include a timestamp sealed to the authority binding system 402; session identifier and authentication context; identity of a traversed decoy verification pathway; behavioral fingerprint of the traversing entity; authentication session outcome; and cross-reference to any cryptographic execution artifact issued proximate to the detection event. The detection and forensic logging system 1140 may be a legal accountability layer, immutable, tamper-evident, and designed for audit, regulatory compliance, and post-hoc forensic attribution, and may be distinct from the attack log 1150, which may be an operational intelligence layer.

In one embodiment, each record of the attack log 1150 may include a complete sequence of verification pathways explored during the probe session; an order and timing of decoy pathway traversals characterizing the exploration strategy; behavioral fingerprint data including interaction timing, input variation characteristics, and API call sequences indicative of systematic state-space exploration; a per-session routing configuration active during the probe of the stochastic routing module 1110; and a cross-reference to a corresponding forensic record of the detection and forensic logging system 1140. The attack log 1150 may be pattern-indexed and queryable, enabling the adaptive evolution engine 126 to identify recurring exploration strategies, classify probe sophistication levels, and detect coordinated multi-session attacks by the same or related probing entities. Unlike the detection and forensic logging system 1140, which may be immutable and sealed for legal purposes, the attack log 1150 may be a living intelligence dataset updated with each probe session and read continuously by the adaptive evolution engine 126.

Continuing to refer to FIG. 10, the adaptive evolution engine 126 may implement a closed feedback loop: unsuccessful decoy pathway traversals may generate records in the attack log 1150; the adaptive evolution engine 126 may analyze those records to characterize the probe exploration strategy; and the adaptive evolution engine 126 may adjust routing weightings of the stochastic routing module 1110 and decoy configuration of the decoy pathway registry 122 to increase the probability that future sessions employing similar exploration strategies encounter decoy pathways earlier in the exploration sequence. Over successive probe sessions, the system 120 may evolve to be optimally adversarial to observed exploration strategies while remaining frictionless for legitimate human users.

Additionally, the adaptive evolution engine 126 may dynamically tune misleading pathway availability signals returned by decoy verification pathways based on the specific exploration strategy observed in records of the attack log 1150. A probe employing a breadth-first exploration strategy may receive different poisoning signals than one employing depth-first or randomized strategies. The poisoning may become increasingly targeted as the adaptive evolution engine 126 accumulates data characterizing the adversary's modeling approach, thereby corrupting the adversary's internal model with progressively higher precision.

In one example, the adaptive evolution engine 126 may employ an optimization algorithm that operates under a dual objective fitness function that simultaneously maximizes two goals: maximum probe difficulty and constant human cognitive load. Regarding maximum probe difficulty, the adaptive evolution engine 126 may minimize the expected number of probe sessions required for an automated system to identify an exploitable authentication gap, by optimizing routing of the stochastic routing module 1110 and configuration of the decoy pathway registry 122 against observed exploration strategies. Regarding constant human cognitive load, the adaptive evolution engine 126 may maintain constant and predictable cognitive load for legitimate human users navigating the authentication interface, such that architectural evolution may not increase friction or error rates for genuine human principals.

In one example, the adaptive evolution engine 126 may be extended to continuously monitor public threat intelligence feeds in real time, incorporating emerging attack patterns from external sources beyond probes against its own system. The adaptive evolution engine 126 may also source from open-source security materials—CVE databases, published attack methodologies, and security research—as additional training signal to evolve decoy configuration and routing parameters. The adaptive evolution engine 126 may operate off-path, reading from the attack log 1150 over time, analyzing accumulated probe behavior records, and evolving routing parameters and decoy configuration based on that analysis.

In terms of adversarial asymmetry inversion properties, the system 120 may provide for: mandatory state-space coverage, wherein a probe seeking an exploitable gap must explore the full apparent state space and decoy pathways may be distributed such that systematic exploration will encounter them; single-event detection sufficiency, wherein a defender may detect probe activity upon any single decoy traversal regardless of how many prior sessions preceded detection; per-session architectural non-reproducibility, wherein the stochastic routing module 1110 may ensure each probe session presents a different architectural surface; covert detection permanence, wherein a probing entity may not distinguish evasion from detection; adversarial model corruption, wherein decoy signals may corrupt the adversary's internal model progressively such that increased sophistication may accelerate corruption rather than improve bypass reliability; and active learning evolution, wherein each attack attempt may train the adaptive evolution engine 126, making the architecture progressively more adversarial to observed probe strategies while holding human experience constant.

It will be appreciated that the stochastic routing module 1110 may use cryptographically secure random number generators, the decoy pathway registry 122 may be a database, the detection and forensic logging system 1140 may use mature tamper-evident logging technology integrated with an authority binding system, the attack log 1150 may include a structured database with pattern-indexing, and the adaptive evolution engine 126 may use established reinforcement learning or optimization techniques applied to the parameters of the stochastic routing module 1110. In this regard, the system 120 may be a deployable infrastructure, not a research roadmap.

In one example embodiment, the CMAI system 120 may be implemented as a component layer within the authorization system 302 (FIG. 3), which requires biometric verification of genuine human presence before issuing a cryptographic execution artifact authorizing an AI agent to perform a specified action. The CMAI system 120 may govern the internal structure of the biometric verification process within such an authorization system. Accordingly, the disclosed concept may provide an architecture that inverts the unfavorable adversarial asymmetry associated with traditional authentication security by turning the adversary's own optimization logic against it, such that the act of probing constitutes a detectable event, the architectural surface cannot be reliably modeled regardless of probe sessions, and the CMAI system 120 actively learns from each failed attack attempt to become progressively harder to defeat.

FIG. 11 shows a system 1202, in accordance with another non-limiting embodiment of the disclosed concept, which includes the authorization system 1006 (incorporating the authorization system 302 (FIG. 3) and the authority binding system 402 (FIG. 4)), the deterministic control system 502 (FIG. 5), the conditioning system 802 (FIG. 7), and the CMAI system 120 (FIG. 10), each of which may be communicable over an internet/network 1204.

In one example, in addition to detecting probes against a verification gate of the authorization system 302 (FIG. 3), the CMAI system 120 may also activate on any block event generated by the execution gate mechanism 540 of the deterministic control system 502 (FIG. 5). When the deterministic control system 502 (FIG. 5) blocks an action due to absence of a valid artifact, that block event may serve as a deterministic trigger for engagement of the CMAI system 120 (FIG. 10). The triggering condition may be binary—valid artifact present or not—which means activation of the CMAI system 120 may require no behavioral inference, no anomaly scoring, and no probabilistic judgment. In this regard, the block of the deterministic control system 502 (FIG. 5) may be a sole and sufficient trigger.

Continuing to refer to FIG. 11, when the CMAI system 120 engages an unauthorized agent following a block event of the deterministic control system 502, the decoy pathways may return corrupted intelligence to that agent, which may then carry that corrupted intelligence back to whatever system sent it. The originating system may then act on corrupted data, degrading its ability to mount future attacks. The more sophisticated and systematic the probing agent, the more deeply the poison may propagate into the originating system, such that the attack vector may become a delivery mechanism for the poison.

In addition to activating on block events of the deterministic control system 502, the CMAI system 120 may also activate on block events generated by the pre-gate of the conditioning system 802. When the external agreement and permission structure rejects an agent-to-agent interpretation handshake, that rejection may be a block event. The CMAI system 120 in the system 1202 may engage the sending agent following that block by returning corrupted interpretation signals through decoy pathways rather than a clean rejection. The sending agent may carry that corrupted intelligence back to its originating system, degrading its ability to construct an accurate model of the permission structure of the conditioning system 802 for future probing attempts.

Importantly, the CMAI system 120 may not activate on every block of the conditioning system 802, as legitimate agent-to-agent misinterpretation may be a normal operational condition rather than adversarial probing. Activation on blocks of the conditioning system 802 may be conditioned on a detection pattern indicating systematic or repeated probing behavior rather than a single legitimate failure. This threshold-based activation may distinguish adversarial state-space exploration from ordinary miscommunication between authorized agents. Accordingly, the architecture of the CMAI system 120 may be extended to protect both the pre-gate coordination layer and the execution boundary, creating a layered defensive system that may cover a full enforcement stack.

Regarding atomic block events and on-demand decoy selection: a block event from the execution gate mechanism 540 (FIG. 5) may be atomic. Once the CMAI system 120 determines that no valid artifact is present and a block condition is met, there may be no intermediate state in which an attacking agent can modify its behavior to avoid decoy engagement. The decision to route into a decoy pathway may be made at the instant of the block event. The specific decoy pathway may not be fully determined or enumerated in advance; instead, the stochastic routing module 1110 may select or compose a decoy path at the moment of the block event using internal rules and configuration parameters. As a result, even if an adversary understands the general architecture, the adversary may not reliably predict which decoy sequence will be presented on any given block. The architecture of the CMAI system 120 may thus ensure that knowledge of the method does not enable reliable evasion—the CMAI system 120 has choreographed stochastic decoy pathways that are internally structured, externally non-deterministic.

Furthermore, the adaptive evolution engine 126 (FIG. 10) of the CMAI system 120 may also continuously learn from both internal and external signals. Internally, the adaptive evolution engine 126 may analyze historical block events, decoy traversals, and probe patterns against the protected gates to refine decoy configurations and routing parameters over time. Externally, the adaptive evolution engine 126 may consume publicly available threat intelligence and security research (e.g., open-source threat-intel feeds, CVE databases, published attack methodologies, security advisories, and related research) as additional training signal. These external inputs may be distilled into updated decoy patterns, thresholds, and routing parameters that are delivered as versioned software/configuration updates to the boundary component, not as live self-modification in the hot path. The enforcement surface may remain lightweight and deterministic at runtime. The adaptive evolution engine 126 may operate off-path, generating updated decoy configurations that can be deployed under operator control.

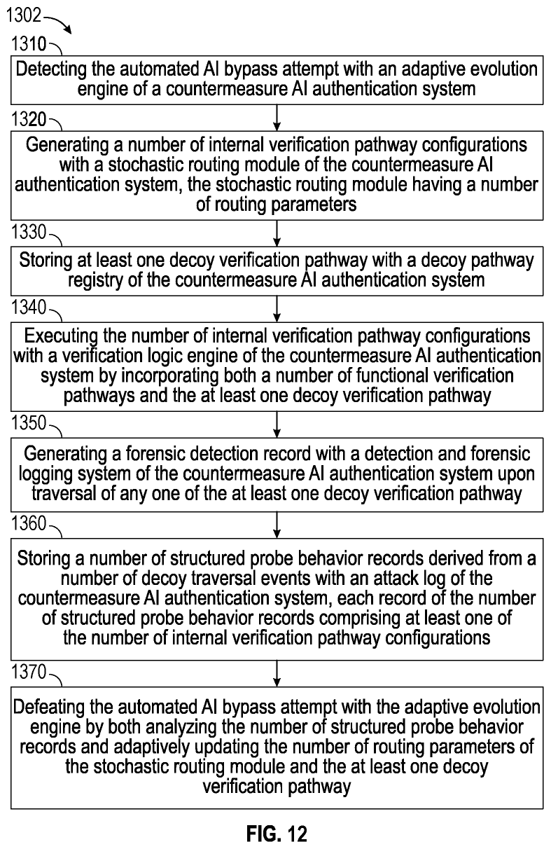

FIG. 12 shows a computer-implemented method 1302 for detecting and defeating an automated AI bypass attempt. In one example, the method 1302 comprises a first step 1310 of detecting the automated AI bypass attempt with an adaptive evolution engine 126 of a CMAI system 120; a second step 1320 of generating a number of internal verification pathway configurations with a stochastic routing module 1110 of the CMAI system 120, the stochastic routing module 1110 having a number of routing parameters; a third step 1330 of storing at least one decoy verification pathway with a decoy pathway registry 122 of the CMAI system 120; a fourth step 1340 of executing the number of internal verification pathway configurations with a verification logic engine 1130 of the CMAI system 120 by incorporating both a number of functional verification pathways and the at least one decoy verification pathway; a fifth step 1350 of generating a forensic detection record with a detection and forensic logging system 1140 of the CMAI system 120 upon traversal of any one of the at least one decoy verification pathway; a sixth step 1360 of storing a number of structured probe behavior records derived from a number of decoy traversal events with an attack log 1150 of the CMAI system 120, each record of the number of structured probe behavior records comprising at least one of the number of internal verification pathway configurations; and a seventh step 1370 of defeating the automated AI bypass attempt with the adaptive evolution engine 126 by both analyzing the number of structured probe behavior records and adaptively updating the number of routing parameters of the stochastic routing module 1110 and the at least one decoy verification pathway.

In one example, the method 1302 may further include activating the verification logic engine 1130 responsive to a block event (e.g., without limitation, a binary block event), whereupon the verification logic engine 1130 may route a corresponding blocked agent into a decoy pathway as configured by the stochastic routing module 1110. In one example, this engagement may happen in real time at the moment of the block. The block event may be a binary block event generated by the execution gate mechanism 540 of the deterministic control system 502. In this instance, activating may be performed without requiring at least one or each of behavioral inference, anomaly scoring, and probabilistic judgment, in order that the binary block event may be provided as a sole and sufficient trigger for engagement of the CMAI system 120. Additionally, the block event in the method 1302 may be generated with a human authorization module 310 of an authorization system 302.

Regarding incorporation of the conditioning system 802 in the system 1202, the method 1302 may further include all of the steps of the method 902 (FIG. 8), as well as a step of providing a determination that the second exchange 826 does not satisfy the configured permission criteria 832 as the block event. In this instance, the method 1302 may further include engaging the first autonomous AI agent 810 with the CMAI system 120 responsive to the block event by returning a number of corrupted interpretation signals through the at least one decoy verification pathway.

In some embodiments of the disclosed concept, the method 1302 may further include maintaining with the decoy pathway registry 122 a number of non-functional decoy verification pathways that are reachable only through AI systematic state-space exploration, thereby allowing adversarial training data poisoning signals to be returned to an originating system upon traversal. The second step 1320 may be performed using a cryptographically seeded non-deterministic routing function, and the fifth step 1350 may be performed without modifying an outcome of an authentication session in a manner detectable by a traversing entity. Furthermore, the method 1302 may also include: presenting the at least one decoy verification pathway as a valid authentication pathway to an automated probe performing systematic state-space exploration while remaining unreachable through authentic human interaction; providing with each record of the number of structured probe behavior records an exploration pathway sequence and a behavioral fingerprint; and employing a number of observed probe exploration strategies with the adaptive evolution engine 126 such that authentication of the CMAI system 120 becomes progressively harder to defeat through automated probing over successive attack sessions.

In other embodiments of the disclosed concept, the cryptographic artifacts generated throughout the system 1202 may be algorithm-agnostic and compatible with post-quantum cryptographic standards. The architecture of the system 1202 may not depend on any specific cryptographic algorithm. Furthermore, in some examples the stochastic routing module 1110 and the verification logic engine 1130 may be implemented at the chip or firmware level rather than in software, providing hardware-enforced verification architecture that cannot be modified at runtime. The CMAI system 120 may be deployed at a Model Context Protocol gateway layer, such that every tool call or API invocation attempted by an unauthorized agent may be intercepted before any side effect occurs. Additionally, the attack log 1150 may be configured to detect coordinated multi-session attacks by the same or related probing entities across different sessions and different enforcement boundaries simultaneously.

More broadly, the verification artifacts generated throughout the system 100, the system 502, the system 802, the system 1002, and the system 1202 may each be mechanism-agnostic. As used herein, a “verification artifact” is a verifiable identity and authorization construct that may include one or more elements generated via cryptographic methods, post-quantum cryptographic methods, quantum-derived processes including quantum randomness or quantum state measurement, biometric inputs, device-bound credentials, or other mechanisms capable of producing a verifiable identity or authorization assertion, or combinations thereof. The cryptographic artifact described throughout the foregoing embodiments is one species of verification artifact in which the verifiable elements are generated via classical or post-quantum cryptographic methods. Validation of a verification artifact is independent of any specific cryptographic scheme and is based on satisfaction of one or more identity or authorization conditions associated with the communication. In some embodiments, the verification artifact is constrained by at least one of temporal validity, single-use enforcement, contextual parameters, device association, or communication-state conditions. In some embodiments, the verification artifact includes a component derived from a quantum process, including quantum randomness, quantum state measurement, or quantum-secured communication.

In some embodiments, the verification artifact further encodes a permission envelope that specifies one or more transmission constraints governing what the sender is permitted to transmit and, in conjunction with a receiver authenticator application, what the receiver is permitted to do with the received communication. The permission envelope is associated with the identity anchor at the time of enrollment and is evaluated by the signing layer prior to generating the verification artifact for each proposed outbound communication. If the proposed outbound communication satisfies all transmission constraints of the permission envelope, the signing layer proceeds to generate the verification artifact in the ordinary course. If the proposed outbound communication violates a transmission constraint of the permission envelope, the signing layer performs at least one of: withholding the verification artifact such that the outbound communication is transmitted without a valid artifact and is therefore rejected by a compliant receiver authenticator application, generating the verification artifact with an enforcement flag that instructs the receiver authenticator application to block delivery upon receipt, or blocking transmission of the outbound communication at the signing layer before any data leaves the device.

The permission envelope may specify constraints including, without limitation, permitted recipient identities or classes, permitted destination endpoints, content classification restrictions, permitted actions on the received communication, and temporal validity conditions. Because the permission envelope is encoded in the verification artifact and evaluated at the signing layer, enforcement occurs at the communication boundary prior to transmission rather than through post-delivery detection or network-layer filtering.

Two enterprise use cases illustrate the practical application of this embodiment. In a first use case, an organization enrolling employees in the identity anchor system incorporates a permission policy into the permission envelope restricting certain outbound communications. For example, an employee's permission envelope may prohibit transmission of communications containing content classified as sensitive corporate data to personal telephone numbers or personal electronic mail addresses outside the corporate domain. The signing layer evaluates this constraint at the moment of signing. If the proposed outbound communication is addressed to a destination that violates the permission envelope, the verification artifact is either not generated or is generated with an enforcement flag. A receiver authenticator application operating at any compliant receiving system enforces the flag, and the communication does not arrive. This architecture prevents employee-to-self data exfiltration at the communication boundary, enforced structurally through the identity anchor enrollment rather than through external network monitoring or post-transmission detection.

In a second use case, an employee copies sensitive corporate data and attempts to paste it into a consumer artificial intelligence system operating as an external large language model or other AI endpoint. Because the signing layer intercepts all outbound communications regardless of application or platform, it evaluates the proposed transmission against the permission envelope before any data leaves the device. If the permission envelope classifies the destination as a prohibited AI endpoint or classifies the content as sensitive under applicable content classification constraints, the signing layer blocks the outbound communication before transmission occurs. This governs shadow AI data exfiltration at the communication boundary, operating prior to and independent of network-layer controls, platform-level restrictions, or post-transmission detection systems. The enforcement is a structural property of the identity anchor enrollment and the signing layer interception architecture, not a configurable application-level preference.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Unless otherwise specified, the illustrated embodiments are to be understood as providing features of varying detail of some ways in which the inventive concepts may be implemented in practice. Therefore, unless otherwise specified, the features of the various embodiments may be otherwise combined, separated, interchanged, and/or rearranged without departing from the inventive concepts.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “may include,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, may be used as terms of approximation and not as terms of degree, and, as such, are utilized to account for inherent deviations in measured, calculated, and/or provided values that would be recognized by one of ordinary skill in the art.

As employed herein, the term “number” shall mean one or an integer greater than one (i.e., a plurality).

Thus, although specific embodiments are described herein for illustrative purposes, various equivalent modifications are possible within the scope of the present description, as those skilled in the relevant art will recognize. The teachings provided herein can be applied to other systems and methods for human identity-bound cryptographic signing of digital communications, and not just to the embodiments described above and shown in the accompanying figures. Accordingly, the scope of the embodiments described above should be determined from the following claims.

What is claimed is:

1. A system for authenticating digital communications comprising:
a signing layer configured to intercept outbound communications from a verified human identity prior to transmission, wherein the verified human identity is registered to a public identity record;
an identity anchor binding a signing key to the verified human identity; and a verification artifact generated by the signing layer, the verification artifact encoding the identity anchor of the verified human identity.

2. The system of claim 1, wherein the verification artifact comprises one or more verifiable elements generated using at least one of: a cryptographic method, a post-quantum cryptographic method, a quantum-derived process, a biometric input, and a device-bound credential, wherein validation of the verification artifact is independent of any specific cryptographic scheme and is based on satisfaction of at least one authorization condition associated with the outbound communications.

3. The system of claim 2, wherein the verification artifact includes a component derived from a quantum process, comprising at least one of a quantum randomness, a quantum state measurement, and a quantum-secured communication.

4. The system of claim 2, wherein the verification artifact comprises a state indicator that validates a communication as one of: human-authored communication, AI-assisted communication, and AI-generated communication under authorization.

5. The system of claim 4, wherein communications validated as AI-generated under authorization comprise a cryptographic reference to a human authorization event invoking AI-generation of the AI-generated communication under authorization, wherein the human authorization event encodes the identity anchor of the verified human identity.

6. The system of claim 5, wherein the AI-generated communication under authorization is produced using a user-specific communication style model that is accessible only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

7. The system of claim 4, wherein a modification to the outbound communications subsequent to generation of the verification artifact invalidates the verification artifact.

8. The system of claim 1, further comprising a receiver layer comprising a public verification protocol enabling a receiving system to receive the outbound communications and validate the verification artifact against the public identity record to confirm authenticity of the outbound communications.

9. The system of claim 7, wherein an artifact verification failure resulting from invalidation of the verification artifact is recorded in an immutable audit log within a receiver layer.

10. The system of claim 9, wherein artifact verification failures recorded in the immutable audit log serve as deterministic triggers for engagement of a countermeasure authentication system configured to present at least one deceptive verification pathway to an originating source of the artifact verification failures.

11. The system of claim 9, wherein artifact verification failures are aggregated across a plurality of communication events by an attacker attribution module.

12. The system of claim 11, wherein exceeding a threshold of artifact verification failures initiates a deceptive response communicated to an originating source of digital communications that elicited the artifact verification failures, wherein the deceptive response appears as a successful delivery and returns at least one of false intelligence and corrupted intelligence to the originating source.

13. The system of claim 8, wherein a receiver authenticator application operating on the receiving system operates as a persistent background verification layer and rejects communications lacking the verification artifact validated against the public identity record.

14. The system of claim 13, wherein the receiver authenticator application receives a state indicator encoded in the verification artifact and surfaces the state indicator as a filterable signal within a communication interface of the receiver authenticator application.

15. The system of claim 8, wherein revocation of the signing key when compromised is transmitted as a signed revocation artifact through the signing layer and to the receiving system without dependency on external revocation infrastructure, the signed revocation artifact processed by a receiver authenticator application upon receipt.

16. The system of claim 1, wherein the signing layer operates within a trusted execution environment of a computing device on which the signing layer is installed, such that verification artifact generation is isolated from an application layer of the computing device and inaccessible to unauthorized software.

17. The system of claim 1, wherein the verification artifact further encodes a permission envelope specifying one or more transmission constraints applicable to the outbound communication, wherein the signing layer evaluates the permission envelope prior to generating the verification artifact and, upon determining that the proposed outbound communication violates a transmission constraint of the permission envelope, performs at least one of: withholding the verification artifact, generating the verification artifact with an enforcement flag, and blocking transmission of the outbound communication.

18. A method for authenticating digital communications comprising:
intercepting, by a signing layer, outbound communications from a verified human identity prior to a transmission of the outbound communications, wherein the verified human identity is registered to a public identity record;
binding, by an identity anchor, a signing key to the verified human identity; and
producing, by the signing layer, a verification artifact encoding the identity anchor of the verified human identity.

19. The method of claim 18, further comprising encoding a state indicator in the verification artifact that validates a communication as one of: human-authored communication, AI-assisted communication, and AI-generated communication under authorization.

20. The method of claim 19, wherein encoding the state indicator as AI-generated communication under authorization comprises including in the verification artifact a cryptographic reference to a human authorization event invoking AI-generation of the AI-generated communication under authorization, wherein the human authorization event encodes the identity anchor of the verified human identity.

21. The method of claim 20, wherein producing the AI-generated communication under authorization comprises accessing a user-specific communication style model only upon presentation of a valid authorization artifact satisfying requirements of the identity anchor of a style model owner, wherein the style model encodes relational variation comprising distinct communication styles derived from passive observation of outbound communications of the style model owner across a plurality of recipient categories, and wherein the verification artifact for the AI-generated communication under authorization encodes a reference to an invocation event of the style model, the human authorization event, and the identity anchor of the style model owner.

22. The method of claim 18, further comprising receiving, by a receiver layer, the outbound communications; and validating, by a public verification protocol on the receiver layer, the verification artifact against the public identity record to confirm authenticity of the outbound communications.

23. The method of claim 22, further comprising recording an artifact verification failure resulting from an invalidation of the verification artifact in an immutable audit log within the receiver layer.

24. The method of claim 23, further comprising, upon recording an artifact verification failure in the immutable audit log, deterministically triggering engagement of a countermeasure authentication system configured to present at least one deceptive verification pathway to an originating source of the artifact verification failure.

25. The method of claim 22, further comprising operating a receiver authenticator application on a receiving system as a persistent background verification layer, wherein the receiver authenticator application rejects communications lacking the verification artifact validated against the public identity record.

26. The method of claim 25, further comprising receiving, by the receiver authenticator application, a state indicator encoded in the verification artifact and surfacing the state indicator as a filterable signal within a communication interface of the receiver authenticator application.

27. The method of claim 22, further comprising transmitting a signed revocation artifact through the signing layer to a receiving system upon compromise of the signing key, without dependency on external revocation infrastructure, wherein the signed revocation artifact is processed by a receiver authenticator application upon receipt.

28. The method of claim 22, wherein intercepting outbound communications comprises operating the signing layer as a discrete application installed on a computing device without requiring platform-level, device-level, or carrier-level integration, and wherein validating the verification artifact comprises executing the public verification protocol by a receiver-side verification application separately installed on a computing device.

29. The method of claim 18, wherein intercepting outbound communications and producing the verification artifact each comprise operating within a trusted execution environment of a computing device such that verification artifact generation is isolated from an application layer of the computing device and inaccessible to unauthorized software.

30. The method of claim 18, wherein the verification artifact further encodes a permission envelope specifying one or more transmission constraints applicable to the outbound communication, wherein the signing layer evaluates the permission envelope prior to producing the verification artifact and, upon determining that the proposed outbound communication violates a transmission constraint of the permission envelope, performs at least one of: withholding the verification artifact, producing the verification artifact with an enforcement flag, and blocking transmission of the outbound communication.
